(19) United States
(12) Patent Application Publication
(10) Pub. No.: US 2026/0226940 A1
(43) Pub. Date: Aug. 6, 2026

(54) ROTATION SUPPORT DEVICE FOR FLYING OBJECT

(71) Applicant: NSK LTD., Tokyo (JP)

(72) Inventors: Nagao DOHI, Fujisawa-shi (JP); Azuma ITO, Fujisawa-shi (JP); Tomoharu SAITOU, Fujisawa-shi (JP); Masafumi HIKIDA, Fujisawa-shi (JP)

(73) Assignee: NSK LTD., Tokyo (JP)

(21) Appl. No.: 19/153,071

(22) PCT Filed: Jan. 11, 2024
(86) PCT No.: PCT/JP2024/000385

§ 371 Date: Aug. 1, 2025

(30) Foreign Application Priority Data
Feb. 8, 2023 (JP) 2023-017623
Aug. 25, 2023 (JP) 2023-136974
Sep. 4, 2023 (JP) 2023-142660

(51) Int. Cl. F16C 19/08; F16C 33/72

(52) U.S. Cl. CPC F16C 19/08; F16C 33/723; F16C 2380/26

(57) ABSTRACT

A rotation support device for flying object has a stationary body having double-row outer ring raceways on an inner circumferential surface thereof and capable of supporting a motor stator, a rotating body having double-row inner ring raceways on an outer circumferential surface thereof and capable of supporting a motor rotor and a propeller, and a plurality of rolling elements arranged between the double-row outer ring raceways and the double-row inner ring raceways so as to be able to roll freely, at least one outer ring raceway of the double-row outer ring raceways directly formed on the inner circumferential surface of the stationary body and/or at least one inner ring raceway of the double-row inner ring raceways directly formed on the outer circumferential surface of the rotating body 3.

### TECHNICAL FIELD

The present disclosure relates to a rotation support device for flying object, which for supporting a propeller and a drive motor of a flying object.

### BACKGROUND ART

A flying object such as a drone includes an airframe, a propeller for obtaining lift, and a rotational drive device for flying object which rotatably supports the propeller with respect to the airframe and rotationally drives the propeller.

As described in JP 2020-072530A, a rotational drive device for flying object having a conventional structure includes a rotation support device for flying object including a stationary body, a rotating body, and a bearing, and a drive motor including a motor stator and a motor rotor.

The stationary body has an inner circumferential surface and is supported and fixed to the airframe of the flying object.

The rotating body has an outer circumferential surface and is supported through the bearing with respect to the stationary body so as to be able to rotate freely about a central axis of rotation in the vertical direction.

The motor stator includes a core made of magnetic material and a coil wound around the core, and has magnetic poles on the outer circumferential surface at a plurality of locations uniformly spaced in the circumferential direction. The motor stator is supported and fixed to the stationary body.

The motor rotor has a plurality of magnets at portions facing the outer circumferential surface of the motor stator in the radial direction and is supported and fixed to first side in the axial direction of the rotating body. From the aspect of increasing the output of the drive motor, it is preferable that the radial gap between the motor stator and the motor rotor be as small as possible.

The propeller of the flying object is supported and fixed to an end portion in the axial direction of the rotating body so that its central axis of rotation coincides with the central axis of the rotating body.

In this state, when the coil of the motor stator is energized, electromagnetic force is generated to rotate the motor rotor with respect to the motor stator, and the propeller is rotationally driven together with the motor rotor.

The bearing is configured by a pair of single-row ball bearings arranged separated from each other in the axial direction between the inner circumferential surface of the stationary body and the outer circumferential surface of the rotating body.

### CITATION LIST

### Patent Literature

Patent Literature 1: JP 2020-072530A

### SUMMARY OF INVENTION

### Technical Problem

In the conventional structure described in JP 2020-072530A, each of the pair of single-row ball bearings includes an outer ring, an inner ring, and balls, and is assembled between the stationary body and the rotating body such that the outer circumferential surface of the outer ring is fitted into the inner circumferential surface of the stationary body, and the inner circumferential surface of the inner ring is fitted onto the outer circumferential surface of the rotating body.

In such a conventional structure, there is a tolerance in the width in the radial direction of the single-row ball bearings, that is, there is a tolerance in the difference between the outer diameter of the outer ring and the inner diameter of the inner ring, and there is also a tolerance in the width in the radial direction of portions between the inner circumferential surface of the stationary body and the outer circumferential surface of the rotating body where the single-row ball bearings are arranged. Therefore, accumulation of tolerances when assembling parts of the rotation support device for flying object becomes large, and the coaxiality between the stationary body and the rotating body, that is, the coaxiality between the motor stator and the motor rotor attached to them, tends to decrease. As a result, it becomes difficult to manage the radial gap between the motor stator and the motor rotor so as to keep it small.

An object according to the present disclosure is to provide a rotation support device for flying object that is easy to ensure coaxiality between a motor stator and a motor rotor.

### Solution to Problem

A rotation support device for flying object of an aspect of the present disclosure includes a stationary body, a rotating body, and a plurality of rolling elements.

The stationary body has double-row outer ring raceways on an inner circumferential surface thereof, and is capable of supporting a motor stator.

The rotating body has double-row inner ring raceways on an outer circumferential surface thereof, and is capable of supporting a motor rotor and a propeller.

The plurality of rolling elements are arranged between the double-row outer ring raceways and the double-row inner ring raceways so as to be able to roll freely.

In the rotation support device for flying object of an aspect of the present disclosure, at least one outer ring raceway of the double-row outer ring raceways is directly formed on the inner circumferential surface of the stationary body and/or at least one inner ring raceway of the double-row inner ring raceways is directly formed on the outer circumferential surface of the rotating body.

In the rotation support device for flying object of an aspect of the present disclosure, the stationary body has a stationary fitting portion on an outer circumferential surface thereof onto which the motor stator or an annular member onto which the motor stator is fitted, is able to be fitted.

In the rotation support device for flying object of an aspect of the present disclosure, the rotating body has, at a portion located further to a first side in an axial direction than the stationary body, a rotor contact portion with which a mounting portion of the motor rotor to the rotating body is able to axially come into contact, and a rotor fitting portion onto which the mounting portion of the motor rotor is able to be fitted.

In the rotation support device for flying object of an aspect of the present disclosure, the rotating body has a rotating flange protruding toward an outside in a radial direction at the portion located further to the first side in the axial direction than the stationary body, and the rotor contact portion is configured by a side surface on the first side in the axial direction of the rotating flange.

In the rotation support device for flying object of an aspect of the present disclosure, an outer diameter of the rotating flange is equal to or less than an outer diameter of the stationary fitting portion.

In the rotation support device for flying object of an aspect of the present disclosure, the rotating flange has flange recess portions that open to a second side in the axial direction and to the outside in the radial direction at a plurality of locations in a circumferential direction.

In the rotation support device for flying object of an aspect of the present disclosure, the rotating body has a pilot portion at an end portion on the first side in the axial direction, and the rotor fitting portion is configured by an outer circumferential surface of the pilot portion.

In the rotation support device for flying object of an aspect of the present disclosure, the stationary body has a stationary flange protruding toward an outside in a radial direction at a portion located further to a second side in an axial direction of the stationary fitting portion.

In the rotation support device for flying object of an aspect of the present disclosure, the stationary flange has window holes penetrating in the axial direction at a plurality of locations in a circumferential direction thereof.

The rotation support device for flying object of an aspect of the present disclosure includes an annular member fitted onto the stationary fitting portion of the stationary body.

In the rotation support device for flying object of an aspect of the present disclosure, an outer diameter of the rotating flange is equal to or less than an outer diameter of the annular member.

The rotation support device for flying object of an aspect of the present disclosure includes a first-side seal device that closes an opening on a first side in an axial direction of a rolling element installation space that exists between the inner circumferential surface of the stationary body and the outer circumferential surface of the rotating body.

The rotation support device for flying object of an aspect of the present disclosure includes a second-side seal device that closes an opening on a second side in an axial direction of a rolling element installation space that exists between the inner circumferential surface of the stationary body and the outer circumferential surface of the rotating body.

The rotation support device for flying object of an aspect of the present disclosure includes a bearing cap that closes an opening at an end portion on a second side in an axial direction of the stationary body.

In the rotation support device for flying object of an aspect of the present disclosure,
the double-row outer ring raceways respectively has an arc-shaped cross-sectional shape,
the double-row inner ring raceways respectively has an arc-shaped cross-sectional shape,
the plurality of rolling elements are balls arranged between the double-row outer ring raceways and the double-row inner ring raceways with a back-to-back arrangement contact angle applied, and
a groove shoulder height on a load side of the outer ring raceways and a groove shoulder height on a load side of the inner ring raceways are 25% or more of a diameter of the balls in each row.

In the rotation support device for flying object of an aspect of the present disclosure,
the stationary body consists of a stationary side support member having the double-row outer ring raceways directly formed on the inner circumferential surface thereof, and
the rotating body includes a rotating side support member having an inner ring raceway on a first side in an axial direction of the double-row inner ring raceways directly formed on an outer circumferential surface of the rotating side support member, and an inner ring having an inner ring raceway on a second side in the axial direction of the double-row inner ring raceways directly formed on an outer circumferential surface of the inner ring, the inner ring fitted onto the rotating side support member.

In the rotation support device for flying object of an aspect of the present disclosure, the stationary fitting portion has an inner diameter side engaging groove to which an inner side portion in a radial direction of a retaining ring is able to be engaged, the retaining ring bridged between the stationary fitting portion and the motor stator or the annular member.

In the rotation support device for flying object of an aspect of the present disclosure, the rotating body has a rotating flange that protrudes toward an outside in a radial direction at a portion located further to a first side in an axial direction of the stationary body and to which the motor rotor and the propeller are able to be supported and fixed.

In the rotation support device for flying object of an aspect of the present disclosure, the rotating body has a central hole that opens to an end surface on a first side in an axial direction and/or to an end surface on a second side in the axial direction.

The rotation support device for flying object of the present disclosure can be implemented by appropriately combining the structures of the embodiments described above within a range that does not cause contradictions.

### Effect of Invention

With the rotation support device for flying object of an embodiment of the present disclosure, it is easy to ensure coaxiality between a motor stator and a motor rotor.

### BRIEF DESCRIPTION OF DRAWINGS

FIG. 1 is a cross-sectional view illustrating a rotational drive device including a rotation support device for flying object of a first example of an embodiment of the present disclosure.

FIG. 2 is a perspective view of the rotation support device for flying object of the first example as seen from above.

FIG. 3 is a perspective view of the rotation support device for flying object of the first example as seen from below.

FIG. 4 is a side view of the rotation support device for flying object of the first example as seen from a horizontal direction.

FIG. 5 is a view of the rotation support device for flying object of the first example as seen from above.

FIG. 6 is a view of the rotation support device for flying object of the first example as seen from below.

FIG. 7 is an enlarged view illustrating a portion of FIG. 1.

FIG. 8A and FIG. 8B are schematic views for explaining that torque (rotational resistance) of a ball bearing becomes smaller as a contact angle of the ball bearing increases.

FIG. 9 is a cross-sectional view illustrating a rotation support device for flying object of a second example of an embodiment of the present disclosure.

FIG. 10 is a cross-sectional view illustrating a rotation support device for flying object of a third example of an embodiment of the present disclosure.

FIG. 11 is a cross-sectional view illustrating a rotation support device for flying object of a fourth example of an embodiment of the present disclosure.

FIG. 12 is a cross-sectional view illustrating a rotation support device for flying object of a fifth example of an embodiment of the present disclosure.

FIG. 13 is a cross-sectional view illustrating a rotation support device for flying object of a sixth example of an embodiment of the present disclosure.

FIG. 14 is a cross-sectional view illustrating a rotation support device for flying object of a seventh example of an embodiment of the present disclosure.

FIG. 15 is a cross-sectional view illustrating a rotation support device for flying object of an eighth example of an embodiment of the present disclosure.

FIG. 16 is an enlarged view corresponding to the upper left portion of FIG. 4, illustrating a rotation support device for flying object of a ninth example of an embodiment of the present disclosure.

FIG. 17A is a cross-sectional view illustrating an annular member of a rotation support device for flying object of a tenth example of an embodiment of the present disclosure, and FIG. 17B is a view of the annular member as seen from below FIG. 17A.

FIG. 18A is a cross-sectional view illustrating an annular member of a rotation support device for flying object of an eleventh example of an embodiment of the present disclosure, and FIG. 18B is a view of the annular member as seen from below in FIG. 18A.

FIG. 19 is a cross-sectional view of a rotational drive device including a rotation support device for flying object of a twelfth example of an embodiment of the present disclosure.

FIG. 20 is a cross-sectional view of the rotation support device for flying object of the twelfth example.

FIG. 21 is a view of the rotation support device for flying object of the twelfth example as seen from above in FIG. 20.

FIG. 22 is a cross-sectional view of a rotation support device for flying object of a thirteenth example of an embodiment of the present disclosure.

FIG. 23 is a view of the rotation support device for flying object of the thirteenth example as seen from above in FIG. 22.

### DESCRIPTION OF EMBODIMENTS

### First Example

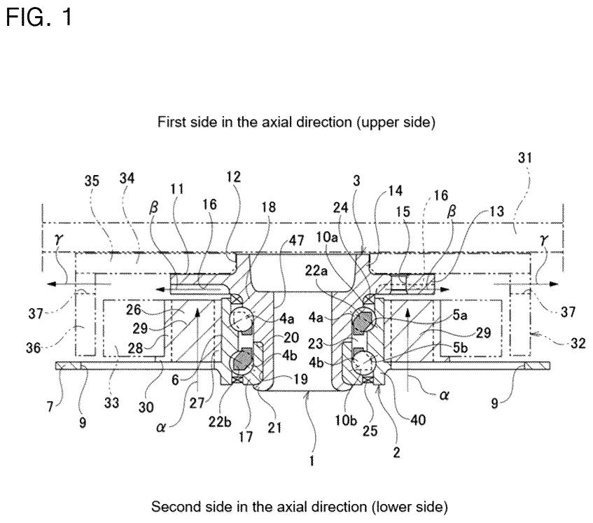

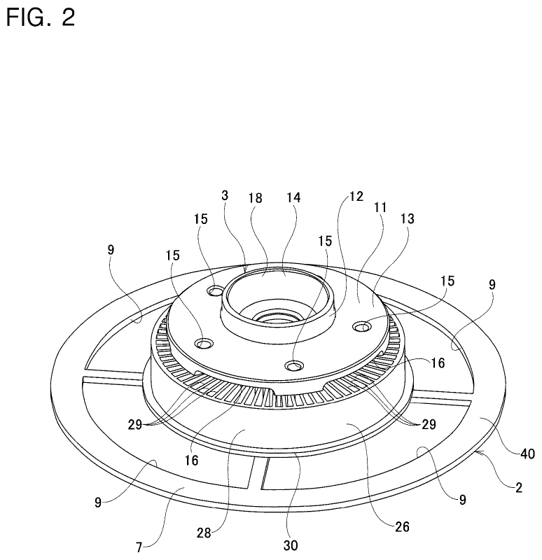

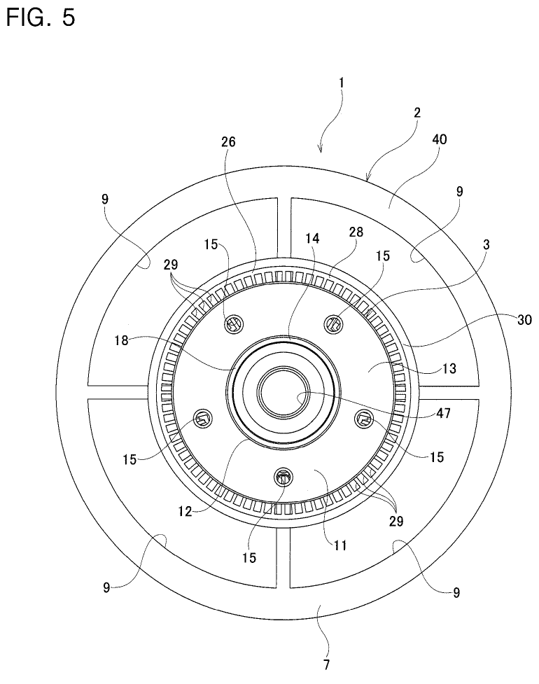

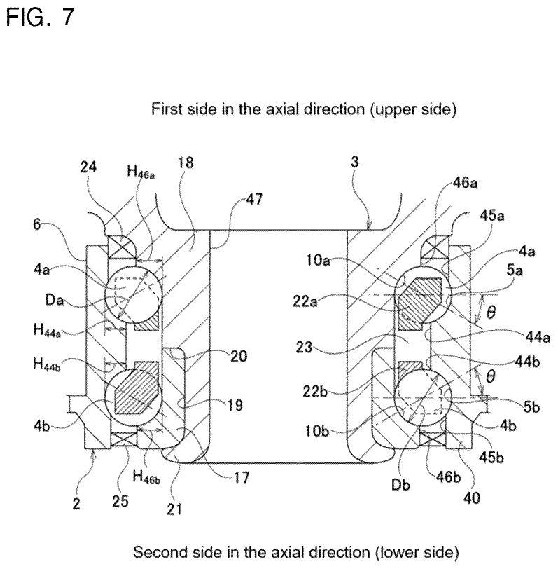

A rotation support device for flying object of a first example of an embodiment of the present disclosure will be described with reference to FIG. 1 to FIG. 8.

A flying object to which the rotation support device for flying object of the present disclosure is applicable includes an airframe, a propeller for obtaining lift, and a rotational drive device for flying object that rotatably supports the propeller with respect to the airframe and rotationally drives the propeller. The flying object may be a large flying object such as a helicopter, or a small flying object such as a drone. In particular, the rotation support device for flying object of the present disclosure may be preferably applied to a logistics drone used for small-lot deliveries.

As illustrated in FIG. 1, the rotational drive device for flying object comprises a rotation support device 1 for flying object and a drive motor 32.

The rotation support device 1 for flying object supports the drive motor 32 and a propeller 31 with respect to the airframe (not illustrated).

The drive motor 32 includes a motor stator 33 and a motor rotor 34, and generates rotational force for rotationally driving the propeller 31.

The rotation support device 1 for flying object of the present example includes a stationary body 2, a rotating body 3, and a plurality of rolling elements 4a, 4b.

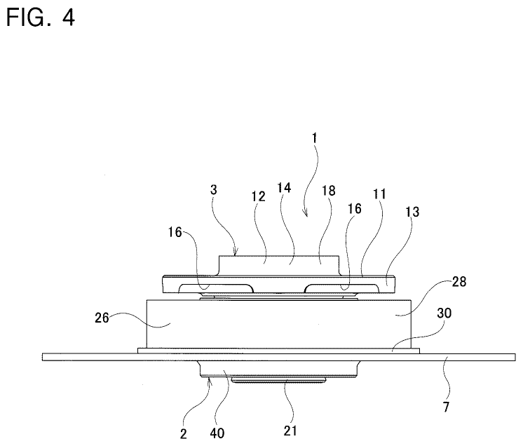

In the following description regarding the rotation support device 1 for flying object, the first side in the axial direction is a side on which the propeller is arranged in an assembled state of the flying object, that is, the upper side in FIG. 1 and FIG. 4.

The stationary body 2 has a pair of outer ring raceways 5a, 5b on the inner circumferential surface and is capable of supporting the motor stator 33. The stationary body 2 is supported and fixed to an airframe of a flying object and does not rotate even when the propeller 31 rotates.

The rotating body 3 has a pair of inner ring raceways 10a, 10b on the outer circumferential surface and is capable of supporting the motor rotor 34 and the propeller 31.

In the rotation support device 1 for flying object of the present example, at least one of the double-row outer ring raceways 5a, 5b is directly formed on the inner circumferential surface of the stationary body 2, and/or at least one of the double-row inner ring raceways 10a, 10b is directly formed on the outer circumferential surface of the rotating body 3.

More specifically, in the present example, the double-row outer ring raceways 5a, 5b are directly formed on the inner circumferential surface of the stationary body 2. That is, the stationary body 2 consists of a stationary side support member 40 having an annular shape, and the double-row outer ring raceways 5a, 5b are formed on the inner circumferential surface of the stationary side support member 40.

Further, of the plurality of inner ring raceways 10a, 10b, the inner ring raceway 10a on the first side in the axial direction is directly formed on the outer circumferential surface of the rotating body 3. That is, the rotating body 3 includes a rotating side support member 18 and an inner ring 17 that is externally fitted onto the rotating side support member 18, and the outer circumferential surface of the rotating body 3 includes the outer circumferential surface of the rotating side support member 18 and the outer circumferential surface of the inner ring 17. The inner ring raceway 10a on the first side in the axial direction is directly formed on the outer circumferential surface of the rotating side support member 18, and the inner ring raceway 10b on the second side in the axial direction is formed on the outer circumferential surface of the inner ring 17.

The plurality of rolling elements 4a, 4b are arranged between the double-row outer ring raceways 5a, 5b and the double-row inner ring raceways 10a, 10b. As a result, the rotating body 3 is rotatably supported on the inside in the radial direction of the stationary body 2.

In the rotation support device 1 for flying object of the present example, the coaxiality between the stationary body 2 and the rotating body 3 can be appropriately ensured compared to a conventional structure in which outer circumferential surfaces of outer rings of a pair of single-row ball bearings arranged separated from each other in the axial direction are fitted into an inner circumferential surface of a stationary side support member, and inner circumferential surfaces of inner rings of the pair of single-row ball bearings are fitted onto an outer circumferential surface of a rotating side support member.

That is, in a conventional structure, there is a tolerance in the width in the radial direction (difference between the outer diameter of the outer ring and the inner diameter of the inner ring) of each of the single-row ball bearings, and there is also a tolerance in the width in the radial direction of portions between the inner circumferential surface of the stationary side support member and the outer circumferential surface of the rotating side support member, where the single-row ball bearings are respectively arranged. As a result, the accumulation of tolerances when the parts are assembled becomes large, and coaxiality between the stationary body configured by the stationary side support member and the pair of outer rings and the rotating body configured by the rotating side support member and the pair of inner rings, that is, coaxiality between the motor stator and the motor rotor, tends to decrease.

In contrast to that, in the rotation support device 1 for flying object of the present example, at least one of the pair of double-row outer ring raceways 5a, 5b (in the present example, both of the double-row outer ring raceways 5a, 5b) is directly formed on the inner circumferential surface of the stationary body 2, and at least one of the pair of double-row inner ring raceways 10a, 10b (in the present example, the inner ring raceway 10a on the first side in the axial direction) is directly formed on the outer circumferential surface of the rotating body 3. That is, since a pair of outer rings and one inner ring can be omitted compared to a conventional structure, the accumulation of tolerances as described above can be mitigated. Accordingly, the coaxiality between the stationary body 2 and the rotating body 3, that is, the coaxiality between the motor stator 33 and the motor rotor 34 can be more easily ensured.

Further, in the present example, since a pair of outer rings and one inner ring can be omitted, the weight of the stationary body 2 and the rotating body 3 can be reduced and the outer diameter of the stationary body 2 can be kept small compared to a structure in which the double-row outer ring raceways 5a, 5b are formed on the inner circumferential surfaces of two outer rings and the inner ring raceway 10a on the first side in the axial direction is formed on the outer circumferential surface of the inner ring. Therefore, it becomes easier to ensure the cruising range of a flying object.

In the structure of the present example, since the outer diameter of the stationary body 2 can be kept small, it is easier to ensure the width in the radial direction of an annular member 26 that is arranged between the outer circumferential surface of the stationary body 2 and the inner circumferential surface of the motor stator 33, making it easier to ensure the heat dissipation performance of the annular member 26. Therefore, it becomes easier to suppress temperature increases in the rotation support device 1 for flying object and the drive motor 32, and to ensure the life of the rotation support device 1 for flying object and the drive motor 32.

At least one of the double-row outer ring raceways 5a, 5b and at least one of the double-row inner ring raceways 10a, 10b is formed on an outer ring or an inner ring (the inner ring 17 in the present example), from the aspect of applying preload to the rolling elements 4a, 4b.

The structures of the double-row outer ring raceways 5a, 5b and the double-row inner ring raceways 10a, 10b are appropriately determined depending on the type of rolling bearing configured by these raceways and the rolling elements 4a, 4b, as well as the type of the rolling elements 4a, 4b.

The rotation support device for flying object according to the present disclosure is not limited to the structure of the present example, however, it has the following specific structures in the present example.

The rotation support device 1 for flying object of the present example additionally includes an annular member 26 having an annular shape. The annular member 26 is externally fitted and fixed onto the stationary body 2.

The annular member 26 has a function as a base for ensuring a large outer diameter dimension of the motor stator 33 while keeping the width dimension in the radial direction of the motor stator 33 small.

In the present example, the motor stator 33 is externally fitted onto the stationary body 2 through the annular member 26. Therefore, compared to a case where the motor stator 33 is directly externally fitted onto the stationary body 2, it is possible to ensure a large outer diameter dimension of the motor stator 33 while keeping a width dimension in the radial direction thereof small. In the present example, by ensuring a large outer diameter dimension of the motor stator 33, output of the drive motor 32, specifically, an electromagnetic force for rotating the motor rotor 34 with respect to the motor stator 33, can be ensured to be large.

The motor stator 33 is formed into an annular shape as a whole and includes magnetic poles at a plurality of locations that are uniformly spaced in the circumferential direction of the outer circumferential surface. The motor stator 33 is externally fitted and fixed onto the annular member 26 and does not rotate during use. The motor rotor 34 is formed into a bottomed cylindrical shape as a whole, includes a cylindrical portion having an inner circumferential surface that faces the outer circumferential surface of the motor stator 33 in the radial direction, and has a plurality of magnets at a plurality of locations that are uniformly spaced in the circumferential direction of the inner circumferential surface of the cylindrical portion. The motor rotor 34 has a mounting portion to the rotating body 3, and the mounting portion is connected and fixed to the rotating body 3 so that the motor rotor 34 rotates integrally with the rotating body 3 during use.

The propeller 31 is connected and fixed to the motor rotor 34 and the rotating body 3, and rotates integrally with the motor rotor 34 and the rotating body 3 during use.

The stationary side support member 40 of the stationary body 2 can be made of a metal such as a ferrous alloy or an aluminum alloy, or a synthetic resin such as carbon fiber reinforced plastic.

In the present example, each of the double-row outer ring raceways 5a, 5b is an angular type and has a cross-sectional shape of approximately a quarter circle. In the present example, the stationary side support member 40 has a groove shoulder portion 44a having a cylindrical surface in a portion of the inner circumferential surface adjacent to the second side in the axial direction of the outer ring raceway 5a on the first side in the axial direction. The groove shoulder portion 44a has an inner diameter smaller than a portion adjacent to the first side in the axial direction of the outer ring raceway 5a. The stationary side support member 40 has a groove shoulder portion 44b having a cylindrical surface in a portion of the inner circumferential surface adjacent to the first side in the axial direction of the outer ring raceway 5b on the second side in the axial direction. The groove shoulder portion 44b has an inner diameter smaller than a portion adjacent to the second side in the axial direction of the outer ring raceway 5b.

In the present example, a middle portion in the axial direction of the inner circumferential surface of the stationary side support member 40, which is located between the double-row outer ring raceways 5a, 5b, is configured by a cylindrical surface whose inner diameter does not change in the axial direction, and the groove shoulder portions 44a, 44b are configured by both end portions in the axial direction of the cylindrical surface respectively.

In the present example, the stationary side support member 40 has a counterbore portion 45a having a cylindrical surface in a portion of the inner circumferential surface adjacent to the first side in the axial direction of the outer ring raceway 5a on the first side in the axial direction. The stationary side support member 40 has a counterbore portion 45b having a cylindrical surface in a portion of the inner circumferential surface adjacent to the second side in the axial direction of the outer ring raceway 5b on the second side in the axial direction. The inner diameter of the counterbore portion 45a on the first side in the axial direction is equal to or slightly smaller than a groove bottom diameter of the outer ring raceway 5a on the first side in the axial direction. The inner diameter of the counterbore portion 45b on the second side in the axial direction is equal to or slightly smaller than a groove bottom diameter of the outer ring raceway 5b on the second side in the axial direction.

The stationary side support member 40 of the stationary body 2 has a stationary fitting portion 6 on the outer circumferential surface onto which the motor stator 33 or the annular member 26 is able to be externally fitted. Although the motor stator 33 may be directly externally fitted onto the stationary fitting portion 6, in the present example, the annular member 26 is externally fitted onto the stationary fitting portion 6.

The stationary fitting portion 6 can be provided in any region of the outer circumferential surface of the stationary side support member 40 as long as the annular member 26 can be externally fitted thereto. In the present example, the stationary fitting portion 6 is provided in an axial range from an end portion on the first side in the axial direction to a portion near an end portion on the second side in the axial direction of the outer circumferential surface of the stationary side support member 40. Furthermore, the stationary fitting portion 6 may be formed in any shape including a cylindrical surface or a stepped cylindrical surface, as long as the annular member 26 can be externally fitted thereto, however, in the present example, it is formed of a cylindrical surface.

In the present example, the stationary body 2 has a stationary flange 7 that protrudes toward the outer side in the radial direction from a portion of the stationary side support member 40 located further to the second side in the axial direction than the stationary fitting portion 6. The stationary flange 7 has a function of supporting and fixing the stationary body 2 to an airframe of a flying object, and a function of determining the position in the axial direction with respect to the stationary body 2 of the annular member 26 or the motor stator 33 that is supported and fixed to the stationary body 2. In the present example, the stationary flange 7 is provided at an end portion on the second side in the axial direction of the stationary side support member 40.

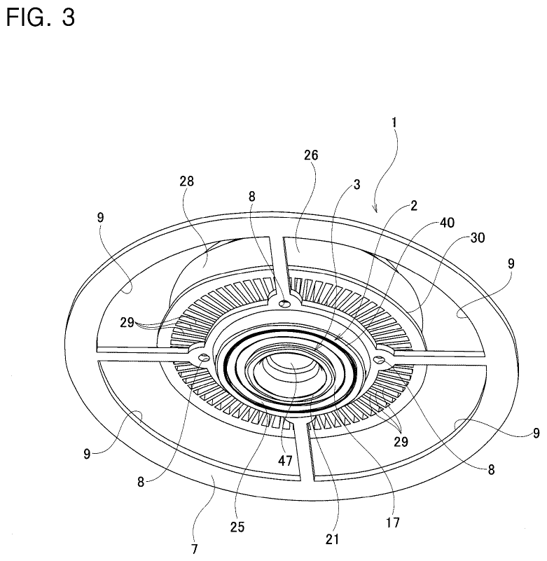

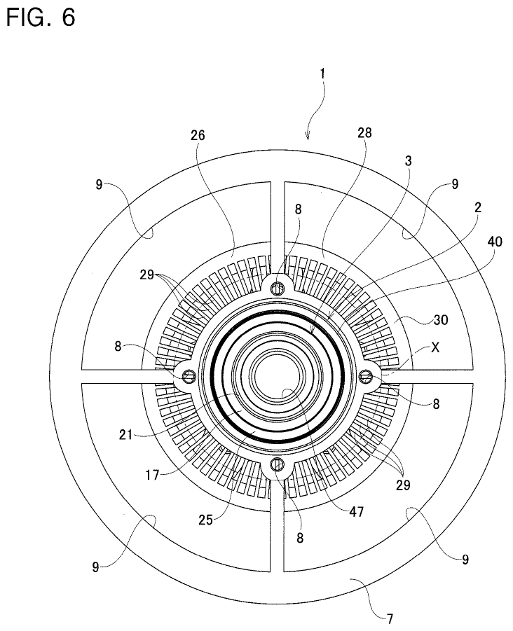

In the present example, the stationary flange 7 has a plurality of support holes 8 penetrating in the axial direction (see FIG. 3 and FIG. 6). The support holes 8 are used to support and fix the stationary body 2 to an airframe of a flying object. Although any means may be used for supporting and fixing the stationary body 2 to the airframe of the flying object using the support holes 8, in the present example, the support holes 8 are configured by screw holes, and bolts inserted through through-holes provided in the airframe of the flying object are screwed into the support holes 8 of the stationary flange 7 from the second side in the axial direction to support and fix the stationary body 2 to the airframe. Alternatively, the support holes 8 may be configured by through-holes, and the bolts inserted through the support holes 8 may be screwed into screw holes provided in the airframe, thereby supporting and fixing the stationary body 2 to the airframe.

The arrangement and number of the support holes 8 are arbitrary as long as the stationary body 2 can be supported and fixed to the airframe. However, in the present example, the support holes 8 are arranged at a plurality of locations uniformly spaced in the circumferential direction on an inner end portion in the radial direction of the stationary flange 7, and the number of the support holes 8 is four. Regarding the arrangement of the support holes 8, the positions in the radial direction of the support holes 8 may also be positions located on the outer side in the radial direction of the motor stator or the motor rotor.

The outer diameter of the stationary flange 7 is arbitrary as long as the stationary body 2 can be supported and fixed to the airframe of the flying object through the support holes 8. In the present example, the outer diameter of the stationary flange 7 is larger than the outer diameter of the motor rotor 34. However, the outer diameter of the stationary flange may also be smaller than that in the present example. Specifically, the outer diameter of the stationary flange may be smaller than the outer diameter of the motor rotor 34, the outer diameter of the motor stator 33, or the outer diameter of the annular member 26. For example, as the structure of the stationary flange, a structure may be adopted in which a portion of the stationary flange 7 of the present example that exists on the outer side in the radial direction of an imaginary circle X in FIG. 6 is omitted, that is, a structure configured only by the inner end portion in the radial direction of the stationary flange 7 of the present example including the plural support holes 8.

The function of supporting and fixing the stationary body 2 to the airframe of the flying object may also be provided to the stationary side support member 40 of the stationary body 2. Specifically, the support holes 8 may be arranged at the second end portion in the axial direction of the stationary side support member 40. Furthermore, a structure may be adopted in which the support holes 8 are omitted and the second end portion in the axial direction of the stationary side support member 40 is internally fitted into a mounting hole provided in the airframe. In such a case, the stationary flange 7 may also be omitted.

In the present example, the stationary flange 7 has window holes 9 that penetrate in the axial direction at a plurality of locations in the circumferential direction of a middle portion in the radial direction. The window holes 9 are provided for ventilation and weight reduction. Although the shape of each window hole 9 is arbitrary, in the present example, the window holes 9 have a fan shape centered around the central axis of the stationary body 2 when viewed from the axial direction. The number of window holes 9 is also arbitrary, but in the present example, the number is four.

Each of the window holes 9 provided in the stationary flange 7 may also be covered with a fine mesh. By doing so, it is possible to ensure the ventilation of the window holes 9 and to prevent the entry of dust from below by the mesh.

In the present example, the stationary body 2 has a configuration in which the stationary side support member 40 and the stationary flange 7 are integrally formed. However, it is also possible to adopt a configuration in which the stationary side support member 40 and the stationary flange 7 are formed as separate parts and then connected and fixed to each other, or a configuration in which an integral component including the stationary side support member 40 and a radially inner portion of the stationary flange 7 and a radially outer portion of the stationary flange 7 are manufactured as separate parts and then connected and fixed to each other.

The rotating body 3 is arranged so as to be coaxial with the stationary body 2 on the inner side in the radial direction of the stationary body 2. Each of the inner ring 17 and the rotating side support member 18 of the rotating body 3 can be made of a metal such as a ferrous alloy or an aluminum alloy, or a synthetic resin such as carbon fiber reinforced plastic.

In the present example, the rotating side support member 18 has a hollow structure provided with a central hole 47 at a central portion in the radial direction. This allows the weight of the rotating side support member 18 to be reduced. In the present example, the central hole 47 is open at an end surface on the first side in the axial direction and at an end surface on the second side in the axial direction of the rotating side support member 18, in other words, the central hole 47 penetrates the central portion in the radial direction of the rotating side support member 18 in the axial direction. This ensures ventilation in the axial direction on the inner side in the radial direction of the rotating side support member 18. However, the central hole 47 of the rotating side support member 18 may also be formed as a bottomed hole open only at either the end surface on the first side in the axial direction or the end surface on the second side in the axial direction, alternatively, the rotating side support member 18 may have a solid structure without a central hole.

In the present example, each of the double-row inner ring raceways 10a, 10b is an angular type and has a cross-sectional shape of approximately a quarter circle. In the present example, the rotating side support member 18 has, on the outer circumferential surface, a groove shoulder portion 46a having a cylindrical surface in a portion adjacent to the first side in the axial direction of the inner ring raceway 10a on the first side in the axial direction which has an outer diameter larger than a portion adjacent to the second side in the axial direction of the inner ring raceway 10a. The inner ring 17 has, on the outer circumferential surface, a groove shoulder portion 46b having a cylindrical surface in a portion adjacent to the second side in the axial direction of the inner ring raceway 10b on the second side in the axial direction which has an outer diameter larger than a portion adjacent to the first side in the axial direction of the inner ring raceway 10b.

In the present example, the rotating side support member 18 has a small-diameter stepped portion 19, to which the inner ring 17 is externally fitted, at a portion located on the second side in the axial direction from the inner ring raceway 10a on the first side in the axial direction. The small-diameter stepped portion 19 has an outer diameter smaller than a portion adjacent to the first side in the axial direction. Furthermore, the rotating side support member 18 has a stepped surface 20 facing the second side in the axial direction at an end portion on the first side in the axial direction of the small-diameter stepped portion 19, and also has a crimped portion 21 bent toward the outside in the radial direction from an end portion on the second in the axial direction of the small-diameter stepped portion 19.

The rotating body 3 is configured by externally fitting the inner ring 17 onto the small-diameter stepped portion 19 of the rotating side support member 18 and holding the inner ring 17 between the stepped surface 20 and the crimped portion 21 of the rotating side support member 18 from both sides in the axial direction, thereby connecting and fixing the inner ring 17 and the rotating side support member 18. In the present example, with this configuration, a preload is appropriately applied to the rolling elements 4a, 4b.

The rotating side support member and the inner ring may also be connected by screwing a nut onto an end portion on the second side in the axial direction that protrudes from an end portion on the second side in the axial direction of inner ring. In a structure in which a crimped portion is not formed on the rotating side support member, the rotating side support member may be made of a non-metal material, for example, a synthetic resin such as carbon fiber reinforced plastic.

The mounting structure of the propeller 31 and the motor rotor 34 with respect to the rotating body 3 may be any structure as long as the propeller 31 and the motor rotor 34 can be appropriately supported and fixed to the rotating body 3. In the present example, the rotating body 3 has a rotor contact portion 11, which is provided in a portion located further to the first side in the axial direction than the stationary body 2 and to which the motor rotor 34 is able to come into contact in the axial direction, and a rotor fitting portion 12, which is provided in a portion located further to the first side in the axial direction than the stationary body 2 and onto which the motor rotor 34 is able to externally fitted. The rotor contact portion 11 and the rotor fitting portion 12 are provided in any portion of the rotating body 3 located further to the first side in the axial direction than the stationary body 2.

In the present example, the rotating body 3 has a rotating flange 13 that protrudes toward the outside in the radial direction from a portion of the rotating side support member 18 located further to the first side in the axial direction than the stationary body 2. The rotating flange 13 has a hollow disc shape. The rotor contact portion 11 is configured by a side surface on the first side in the axial direction of the rotating flange 13.

The outer diameter of the rotating flange 13 is arbitrary, but is preferably smaller than the inner diameter of the motor stator 33. In the present example, the outer diameter of the rotating flange 13 is larger than the outer diameter of the stationary fitting portion 6, and equal to or smaller than the outer diameter of the annular member 26 that is externally fitted onto the stationary fitting portion 6. More specifically, the outer diameter of the rotating flange 13 is slightly smaller than the outer diameter of the annular member 26. Due to this dimensional relationship, after the rotation support device 1 for flying object is assembled, the motor stator 33 can be externally fitted onto the annular member 26 from the first side in the axial direction.

In the present example, the rotating body 3 has a pilot portion 14 that protrudes toward the first side in the axial direction from an end portion on the first side in the axial direction of the rotation-side support member 18. The pilot portion 14 has a cylindrical shape. The rotor fitting portion 12 is configured by an outer circumferential surface of the pilot portion 14.

In the present example, the rotating flange 13 has mounting holes 15 that penetrate in the axial direction at a plurality of locations in the circumferential direction of a middle portion in the radial direction. The mounting holes 15 are used to connect and fix the motor rotor 34 to the rotating flange 13. The mounting holes 15 are formed as screw holes. The number of the mounting holes 15 is arbitrary, but in the present example, the number is five and they are uniformly spaced in the circumferential direction.

In the present example, the rotating flange 13 has a plurality of flange recess portions 16 that open to the second side in the axial direction and to the outside in the radial direction at a plurality of locations in the circumferential direction. The number of the flange recesses 16 is arbitrary, but in the present example, the number is five, and they are uniformly spaced in the circumferential direction. The flange recess portions 16 are used to generate an airflow around the periphery when the rotating body 3 rotates. End portions on the inner side in the radial direction of the flange recess 16 are located on the inner side in the radial direction of the stationary fitting portion 6 respectively. End portions on the outer side in the radial direction of the flange recess 16 are located on the outer side in the radial direction of the stationary fitting portion 6 respectively.

In the present example, the flange recess portions 16 are arranged at positions in the circumferential direction offset from the mounting holes 15. That is, in the rotating flange 13, the mounting holes 15 and the flange recess portions 16 are alternately arranged in the circumferential direction. In the present example, each bottom surface in the axial direction of the plurality of flange recess portions 16 is formed by a flat surface perpendicular to the axial direction of the rotating body 3. However, at least part of the bottom surfaces in the axial direction of the flange recess portions may also be inclined with respect to an imaginary flat plane perpendicular to the axial direction of the rotating body.

The type of the rolling elements 4a, 4b is appropriately determined according to the type of rolling bearing configured by the double-row outer ring raceways 5a, 5b, the double-row inner ring raceways 10a, 10b, and the rolling elements 4a, 4b. In the present example, the rolling elements 4a, 4b are made of a metal such as an iron alloy or a ceramic material, and are configured by balls. Alternatively, tapered rollers may be used as the rolling elements 4a, 4b instead of balls.

In the present example, the rolling elements 4a, 4b arranged in double rows are provided with a contact angle θ of a back-to-back arrangement (DB) and a predetermined amount of preload. The magnitude of the contact angle θ can be arbitrarily determined within a range capable of ensuring required bearing rigidity, for example, within a range of 1° or more and 45° or less. Although the magnitude of the contact angle θ is not limited to this, it is preferably set to 15° or more and 45° or less, and more preferably to 15° or more and 42° ore less. In the present example, the rolling elements 4a, 4b of each row are held by cages 22a, 22b so as to be able to roll freely.

In the present example, a predetermined amount of preload is applied to the rolling elements 4a, 4b in a state where the rotation support device 1 for flying object is assembled, by regulating the force that presses the end surface on the second side in the axial direction of the inner ring 17 with the crimped portion 21. When a structure is adopted in which the end surface on the second side in the axial direction of the inner ring is pressed by a nut screwed onto the end portion on the second side in the axial direction of the rotating side support member, a predetermined amount of preload can be applied to the rolling elements 4a, 4b by regulating the tightening force of the nut.

In the present example, a back-to-back arrangement (DB) contact angle is applied to the rolling elements 4a, 4b, which are arranged in plural for each row between the double-row outer ring raceways 5a, 5b and the double-row inner ring raceways 10a, 10b. Therefore, it is possible to easily ensure the moment rigidity of the rotation support device 1 for flying object without increasing the bearing size such as the diameter or pitch circle diameter of the rolling elements 4a, 4b. That is, when a moment load is applied to the rotation support device 1 for flying object, it becomes easier to suppress the central axis of the stationary body 2 and the central axis of the rotating body 3 from inclining relative to each other.

Regarding the rolling elements 4a, 4b, the relationship between the diameter Da of the rolling elements 4a of the row on the first side in the axial direction and the diameter Db of the rolling elements 4b of the row on the second side in the axial direction is arbitrary, and the diameter Da and the diameter Db may be made equal to each other, or may be made different from each other. In the present example, a configuration in which the diameter Da and the diameter Db are equal is adopted.

The rotation support device 1 for flying object can be applied to both an equal-diameter PCD type structure in which a pitch circle diameter of the rolling elements 4a of a row on the first side in the axial direction and a pitch circle diameter of the rolling elements 4b of a row on the second side in the axial direction are equal to each other, and a different-diameter PCD type structure in which the pitch circle diameters of the rolling elements of respective rows are different from each other. The rotation support device 1 for flying object of the present example includes the equal-diameter PCD type structure.

The rotation support device 1 for flying object may include a structure that seals a rolling element installation space 23 from the outside. The rotation support device 1 for flying object of the present example includes, as such a structure, a first-side seal device 24 that closes an opening on the first side in the axial direction of the rolling element installation space 23 located between the inner circumferential surface of the stationary body 2 and the outer circumferential surface of the rotating body 3, and an second-side seal device 25 that closes an opening on the second side in the axial direction of the rolling element installation space 23. Due to this, it is possible to prevent foreign matters in the external space from entering the rolling element installation space 23 through the openings on both sides in the axial direction of the rolling element installation space 23, and to prevent grease filled in the rolling element installation space 23 from leaking into the external space.

The first-side seal device 24 and the second-side seal device 25 may be configured, for example, by contact-type seal rings that are supported and fixed to the stationary body 2 and that have seal lips with tip portions brought into sliding contact with a surface of the rotating body 3 over the entire circumference. The first-side seal device 24 and the second-side seal device 25 may further include sliding contact rings that are supported and fixed to the rotating body 3 and bring tip end portions of the seal lips into sliding contact on their surfaces.

In the present example, since the seal devices for sealing the rolling element installation space 23 are configured by the two seal devices, the first-side seal device 24 and the second-side seal device 25, the work of assembling the seal devices can be performed more easily compared to a conventional structure in which one seal device is provided on each side in the axial direction of each single-row ball bearing, that is, a total of four seal devices are provided. Furthermore, if the number of seal lips provided in one seal device is the same in the structure of the present example and the conventional structure, the total number of seal devices in the structure of the present example is smaller than that in the conventional structure, thereby reducing the overall seal torque accordingly.

Alternatively, instead of providing the second-side seal device 25 as a structure for sealing the rolling element installation space 23 on the second side in the axial direction from the outside, a configuration may be adopted in which a bearing cap that closes an opening at an end portion on the second side in the axial direction of the stationary body 2 is provided. In this case, in order to prevent communication between the rolling element installation space 23 and the external space, it is preferable to provide a separate closing member that closes the central hole of the rotating side support member, or to make the rotating side support member a solid structure that does not include a central hole penetrating in the axial direction.

In the present example, the annular member 26 not only has a function of ensuring a large outer diameter dimension of the motor stator 33 while keeping the width dimension in the radial direction of the motor stator 33 small, but also functions as a heat exchange member, such as a heat dissipating fin, that efficiently receives heat from the adjacent motor stator 33 and efficiently exchanges heat with the surrounding air in order to facilitate cooling of the drive motor 32.

For this reason, the annular member 26 is made of a metal having high thermal conductivity, such as a copper alloy, an aluminum alloy, or an iron alloy. Further, the annular member 26 has a structure suitable for ensuring a large contact area with the surrounding air, specifically, a structure that has a plurality (or a large number) of ventilation passages at a plurality of locations in the circumferential direction for allowing air to pass through in the axial direction. That is, in the present example, the annular member 26 is configured by a heat exchange member made of metal and having ventilation passages in the axial direction at a plurality of locations in the circumferential direction.

However, the annular member 26 may have only the function of reducing the width in the radial direction of the motor stator 33 while ensuring a large outer diameter of the motor stator 33. In such a case where the annular member 26 does not substantially have a function as a heat exchange member, the annular member 26 may be made of a non-metal material, such as a synthetic resin including carbon fiber reinforced plastic.

In the present example, the annular member 26 includes an inner diameter side cylindrical portion 27, an outer diameter side cylindrical portion 28, and a plurality (a large number) of connecting portions 29.

The inner diameter side cylindrical portion 27 has a cylindrical shape.

The outer diameter side cylindrical portion 28 has a cylindrical shape and is arranged on the outer side in the radial direction of the inner diameter side cylindrical portion 27 so as to be coaxial with each other.

The plurality of connecting portions 29 are uniformly spaced in the circumferential direction between the outer circumferential surface of the inner diameter side cylindrical portion 27 and the inner circumferential surface of the outer diameter side cylindrical portion 28, and each has a flat plate shape extending in the radial direction and the axial direction. Inner end portions in the radial direction of the connecting portions 29 are respectively connected to the outer circumferential surface of the inner diameter side cylindrical portion 27, and outer end portions in the radial direction of the connecting portions 29 are respectively connected to the inner circumferential surface of the outer diameter side cylindrical portion 28. In the present example, the connecting portions 29 function as connecting portions (fin portions) for heat exchange, and spaces between the connecting portions 29 that are adjacent in the circumferential direction form ventilation passages in the axial direction.

In the present example, the outer diameter side cylindrical portion 28 has an outward flange portion 30 protruding toward the outside in the radial direction at an end portion on the second side in the axial direction. The outward flange portion 30 is used to position the motor stator 33 in the axial direction with respect to the annular member 26.

The annular member 26 is externally fitted and fixed to the stationary fitting portion 6 of the stationary body 2. Although the method of fixing the annular member 26 is arbitrary, in the present example, the annular member 26 is press-fitted onto the stationary fitting portion 6 of the stationary body 2 to be fixed to the stationary body 2, and is positioned in the axial direction with respect to the stationary body 2 by bringing a side surface on the second side in the axial direction into contact with a side surface on the first side in the axial direction of the stationary flange 7. Alternatively, as fixing methods for the annular member 26, various fixing methods can be adopted including connecting and fastening using bolts, key press-fitting, pin press-fitting, serration press-fitting, and adhesion. Alternatively, the annular member 26 may be integrally formed with the stationary side support member 40, that is, the annular member 26 and the stationary side support member 40 may be formed as a single part.

In the structure of the present example, since the outer diameter of the rotating flange 13 is larger than the outer diameter of the stationary fitting portion 6, after the stationary body 2 and the rotating body 3 are assembled together through the plurality of rolling elements 4a, 4b, the rotating flange 13 becomes an obstacle, making it impossible to externally fit the annular member 26 onto the stationary fitting portion 6. Therefore, in the present example, the annular member 26 is externally fitted onto the stationary fitting portion 6 in a state before the stationary body 2 and the rotating body 3 are assembled together through the plurality of rolling elements 4a, 4b.

In the present example, in a state where the annular member 26 is externally fitted and fixed to the stationary fitting portion 6 of the stationary body 2, inner side portions in the radial direction of the respective window holes 9 of the stationary flange 7 are arranged so as to be overlapped in the axial direction with the connecting portions 29 of the annular member 26.

In the present example, the motor stator 33 includes a core made of a magnetic material and a coil wound around the core (not illustrated), is formed into an annular shape as a whole, and has magnetic poles at a plurality of locations uniformly spaced in the circumferential direction on the outer circumferential surface. The motor stator 33 is externally fitted and fixed to the outer circumferential surface of the annular member 26 by press fitting or the like, and is positioned in the axial direction with respect to the annular member 26 by bringing an inner end portion in the radial direction of a side surface on the second side in the axial direction into contact with a side surface on the first side in the axial direction of the outward flange portion 30 of the annular member 26.

In the present example, the motor rotor 34 includes a hollow disk-shaped side plate portion 35 which is a mounting portion to the rotating body 3, and a cylindrical tubular portion 36 extending from an outer end portion in the radial direction of the side plate portion 35 toward the second side in the axial direction. The tubular portion 36 has a plurality of ventilation holes 37 penetrating in the radial direction at a plurality of locations in the circumferential direction of an end portion on the first side in the axial direction, and has a plurality of magnets (not illustrated) at a plurality of locations uniformly spaced in the circumferential direction on the inner circumferential surface of an inner end portion in the radial direction of a portion on the second side in the axial direction.

The motor rotor 34 is positioned in the radial direction and axial direction with respect to the rotating body 3 by externally fitting the side plate portion 35 onto the rotor fitting portion 12 without looseness in the radial direction, and bringing an inner side portion in the radial direction of the side surface on the second side in the axial direction of the side plate portion 35 against the rotor contact portion 11, and then the motor rotor 34 is connected and fixed to the rotating flange 13 by screwing bolts which are inserted into through holes (not illustrated) provided at a plurality of locations in the circumferential direction of the side plate portion 35 into the mounting holes 15 of the rotating flange 13. In this state, the plurality of magnets provided on the inner circumferential surface of the tubular portion 36 of the motor rotor 34 closely face the plurality of magnetic poles provided on the outer circumferential surface of the motor stator 33 in the radial direction.

Alternatively, the mounting holes of the rotating flange may be formed as press-fit holes, and the motor rotor may be connected and fixed to the rotating flange by screwing nuts onto tip end portions of stud bolts with press-fitted into the press-fit holes and inserted into the through holes of the side plate portion.

In the present example, by controlling the outer diameter of the outer circumferential surfaces of the rotor fitting portion 12 and the stationary fitting portion 6 or the annular member 26, it is possible to easily control and reduce a gap in the radial direction between the motor stator 33 and the motor rotor 34.

In the present example, the inside of the drive motor 32 can be easily cleaned by removing the motor rotor 34 that is connected and fixed to the rotating body 3 from the rotating body 3.

In the present example, the propeller 31 is connected and fixed to the rotating body 3 through the motor rotor 34 with the central axis of rotation of the propeller 31 aligned with the central axis of the rotating body 3 and a side surface on the second side in the axial direction of a portion around the central axis of rotation of the propeller 31 coming in contact with the side surface on the first side in the axial direction of the side plate portion 35 of the motor rotor 34, by screwing bolts which are inserted into through holes (not illustrated) provided at a plurality of locations in the circumferential direction of the propeller 31 into screw holes (not illustrated) provided at a plurality of locations in the circumferential direction of the side plate portion 35.

In this state, by energizing the coil of the motor stator 33 and generating an electromagnetic force between the plurality of magnetic poles of the motor stator 33 and the plurality of magnets of the motor rotor 34 to rotate the motor rotor 34 with respect to the motor stator 33, the rotating body 3 and the propeller 31 are rotationally driven.

In the present example, when the rotating body 3 rotates, air present inside each of the flange recess portions 16 of the rotating flange 13 is pushed toward outside in the radial direction by the action of centrifugal force. That is, the rotating flange 13 including the plurality of flange recess portions 16 has a pumping function to generate an air flow around the periphery thereof.

Due to this pumping function, in the present example, when the rotating body 3 rotates, air present below the rotation support device 1 for flying object is drawn upward as indicated by an arrow α in FIG. 1 through each of the window holes 9 of the stationary flange 7, and passes between the connecting portions 29 adjacent to each other in the circumferential direction of the annular member 26 from below to above. The air that has passed through enters inside of each of the flange recesses 16 of the rotating flange 13 and is pushed toward outside in the radial direction by the action of centrifugal force as indicated by an arrow β in FIG. 1.

Furthermore, the air that is pushed out is discharged to a space on the outside in the radial direction of the motor rotor 34 through the ventilation holes 37 of the motor rotor 34, as indicated by an arrow γ in FIG. 1. In this manner, in the structure of the present example, heat dissipation of the annular member 26 is efficiently performed by the air flowing in the directions of the arrows α, β, and γ, so that the drive motor 32 is efficiently cooled.

In the present example, groove shoulder portions 44a, 44b are provided on the inner circumferential surface of the stationary side support member 40 adjacent to the load side of the double-row outer ring raceways 5a, 5b, and groove shoulder portions 46a, 46b are provided on the outer circumferential surface of the rotating side support member 18 adjacent to the load side of the double-row inner ring raceways 10a, 10b, and groove shoulder heights of these are specified as described below.

The groove shoulder height H₄₄ₐ on the load side of the outer ring raceway 5a on the first side in the axial direction, that is, a height in the radial direction from a groove bottom portion to the groove shoulder portion 44a, which is the largest diameter portion of the outer ring raceway 5a, is 25% or more of a diameter Da of the rolling elements 4a of a row on the first side in the axial direction that are in rolling contact with the outer ring raceway 5a. The groove shoulder height H₄₄ₐ is preferably 30% or more and 50% or less relative to the diameter Da of the rolling elements 4a, and more preferably 38% or more and 50% or less. In the present example, the groove shoulder height H₄₄ₐ is approximately 37% of the diameter Da.

The groove shoulder height H_{44b} on the load side of the outer ring raceway 5b on the second side in the axial direction, that is, a height in the radial direction from a groove bottom portion to the groove shoulder portion 44b, which is the largest diameter portion of the outer ring raceway 5b, is 25% or more of a diameter Db of the rolling elements 4b of a row on the second side in the axial direction that are in rolling contact with the outer ring raceway 5b. The groove shoulder height H_{44b} is preferably 30% or more and 50% or less relative to the diameter Db of the rolling elements 4b, and more preferably 38% or more and 50% or less. In the present example, the groove shoulder height H_{44b} is approximately 37% of the diameter Db.

The groove shoulder height H₄₆ₐ on the load side of the inner ring raceway 10a on the first side in the axial direction, that is, a height in the radial direction from a groove bottom portion to the groove shoulder portion 46a, which is the smallest diameter portion of the inner ring raceway 10a, is 25% or more of a diameter Da of the rolling elements 4a of a row on the first side in the axial direction that are in rolling contact with the inner ring raceway 10a. The groove shoulder height H₄₆ₐ is preferably 30% or more and 50% or less relative to the diameter Da of the rolling elements 4a, and more preferably 38% or more and 50% or less. In the present example, the groove shoulder height H₄₆ₐ is approximately 46% of the diameter Da.

The groove shoulder height H_{46b} on the load side of the inner ring raceway 10b on the second side in the axial direction, that is, a height in the radial direction from a groove bottom portion to the groove shoulder portion 46b, which is the smallest diameter portion of the inner ring raceway 10b, is 25% or more of a diameter Db of the rolling elements 4b of a row on the second side in the axial direction that are in rolling contact with the inner ring raceway 10b. The groove shoulder height H_{46b} is preferably 30% or more and 50% or less relative to the diameter Db of the rolling elements 4b, and more preferably 38% or more and 50% or less. In the present example, the groove shoulder height H_{46 b} is approximately 46% of the diameter Db.

In the rotation support device 1 for flying object of the present example, with such a configuration, it is possible to appropriately ensure moment rigidity and axial load bearing capacity while suppressing an increase in weight.

That is, since the groove shoulder heights H₄₄ₐ and H_{44b} on the load side of the outer ring raceways 5a, 5b and the groove shoulder heights H₄₆ₐ and H_{46b} on the load side of the inner ring raceways 10a, 10b are set to be 25% or more of the diameter of the rolling elements 4a and 4b, it becomes easier to ensure the axial load bearing capacity of the rotation support device 1 for flying object without increasing the bearing size. Therefore, even when a large axial load is applied to the rotation support device 1 for flying object, the rolling contact surfaces of the rolling elements 4a, 4b in each row are prevented from riding up onto the groove shoulder portions 44a, 44b, 46a, and 46b on the load side.

In order to increase a thrust generated by the propeller 31 to improve the maximum payload of the flying object, it is effective to increase the output of the drive motor 32 and to increase the size of the propeller 31. However, if the size of the propeller 31 increases, a gyro moment load applied to the rotation support device 1 for flying object increases when the flying object changes its posture during flight. In addition, if the thrust generated by the propeller 31 increases, the axial load applied to the rotation support device 1 for flying object increases.

Regarding these points, with the rotation support device 1 for flying object of the present example, it is easier to increase the thrust generated by the propeller 31 since the moment rigidity and axial load bearing capacity is easily ensured. Furthermore, with the rotation support device 1 for flying object of the present example, since the moment rigidity and axial load bearing capacity can be ensured without increasing the bearing size, that is, without increasing the weight of the rotation support device 1 for flying object, the cruising range of the flying object can be easily ensured.

In order to increase the output of the drive motor 32 so as to increase the thrust generated by the propeller 31, it is effective to reduce an air gap between the plurality of magnetic poles provided on the outer circumferential surface of the motor stator 33 and a plurality of S poles and N poles provided on the inner circumferential surface of the tubular portion 36 of the motor rotor 34,. However, if the moment rigidity of the rotation support device 1 for flying object is small, a relative inclination amount between the motor stator 33 supported by the stationary body 2 and the motor rotor 34 supported by the rotating body 3 becomes large when a moment load is applied to the rotation support device 1 for flying object, therefore it is difficult to reduce the air gap from a view point of preventing interference between the magnetic poles and each of the S poles and N poles.

In this regard, with the rotation support device 1 for flying object of the present example, since it is easy to ensure the moment rigidity as described above, the air gap can be easily reduced. Therefore, from this viewpoint as well, it is easy to increase the thrust generated by the propeller 31.

Further, since the groove shoulder heights H₄₄ₐ, H_{44b} on the load side of the outer ring raceways 5a, 5b and the groove shoulder heights H₄₆ₐ, H_{46b} of the inner ring raceways 10a, 10b on the load side are set to 25% or more of the diameter of the rolling elements 4a, 4b, it is easy to increase the contact angle of the rolling elements 4a, 4b while preventing the rolling contact surfaces of the rolling elements 4a, 4b from riding up onto the groove shoulder portions 44a, 44b, 46a, 46b on the load side.

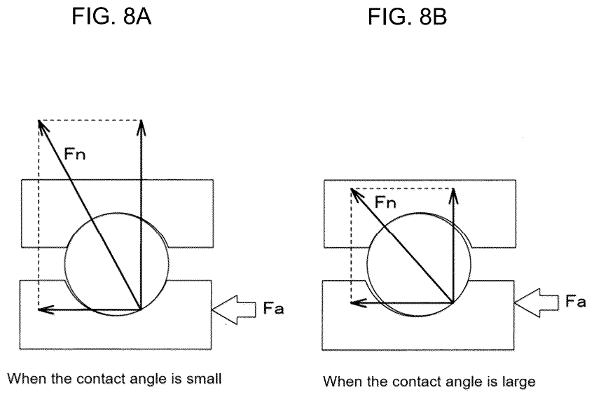

That is, in general, when an axial load Fa of a certain magnitude is applied to a ball bearing, a normal force Fn acting on a rolling contact portion between each of the inner raceway and outer raceways and balls that are rolling elements becomes smaller as the contact angle increases, as illustrated in FIG. 8A and FIG. 8B. Further, the frictional force acting on the rolling contact portion is calculated as a product of a coefficient of friction and the normal force Fn at the rolling contact portion. Therefore, the frictional force acting on the rolling contact portion becomes smaller as the normal force Fn at the rolling contact portion becomes smaller. Furthermore, torque of the ball bearing becomes smaller as the frictional force acting on the rolling contact portion becomes smaller. Accordingly, the torque of the ball bearing becomes smaller as the contact angle of the balls increases.

In the rotation support device 1 for flying object of the present example, since the contact angle of the rolling elements 4a, 4b can be easily increased, the torque (rotational resistance) of the rotation support device 1 for flying object can be easily kept low. Therefore, it becomes easier to ensure rotational efficiency of the propeller 31 by the drive motor 32, and from this view point as well, it is easy to increase the thrust generated by the propeller 31.

### Second Example

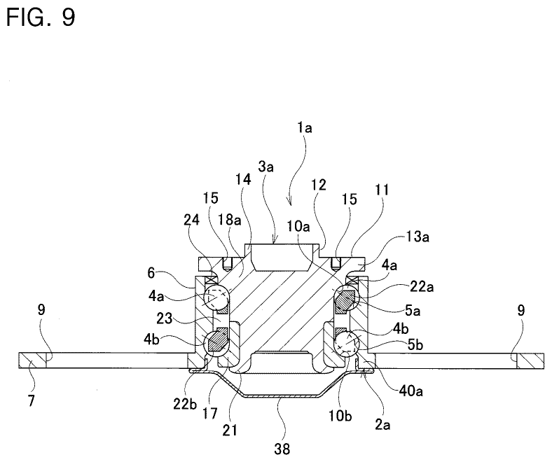

FIG. 9 illustrates a rotation support device for flying object according to a second example of an embodiment of the present disclosure.

In the rotation support device 1a for flying object of the present example, an outer diameter of a rotating flange 13a of a rotating side support member 18a of the rotating body 3a is equal to or smaller than an outer diameter of a stationary fitting portion 6 of a stationary side support member 40a of the stationary body 2a. More specifically, in the present example, the outer diameter of the rotating flange 13a is slightly smaller than the outer diameter of the stationary fitting portion 6. In such a structure of the present example, an annular member can be externally fitted onto the stationary fitting portion 6 after assembling the stationary body 2a, the rotating body 3a, and a plurality of rolling elements 4a, 4b together.

Therefore, the structure of the present example can be shipped as the rotation support device la for flying object that does not include the annular member, and the annular member can be externally fitted onto the stationary fitting portion 6 at a flying object assembly factory or the like. Further, in this structure of the present example, since the outer diameter of the rotating flange 13a is made equal to or smaller than the outer diameter of the stationary fitting portion 6, it contributes to reducing the weight of the rotating body 3a.

The structure of the present example does not include a second-side seal device that closes an opening on the second side in the axial direction of the rolling element installation space 23. Instead, the structure of the present example includes a bearing cap 38 that closes an opening at an end portion on the second side in the axial direction of the stationary body 2a. In the present example, the bearing cap 38 is formed into a cup shape from a metal plate such as a steel sheet, and is connected to the stationary body 2a by being press-fitted into an end portion on the second side in the axial direction of the stationary body 2a.

In the present example, in order to prevent communication between the rolling element installation space 23 and the external space, the rotating side support member 18a is formed in a solid structure that does not include a central hole penetrating in the axial direction. However, it is also possible to prevent communication between the rolling element installation space and the external space by forming the rotating side support member in a hollow structure that includes a central hole penetrating in the axial direction, and by providing a closing member that closes the central hole.

Other configurations and effects of the second example are the same as those of the first example.

### Third Example

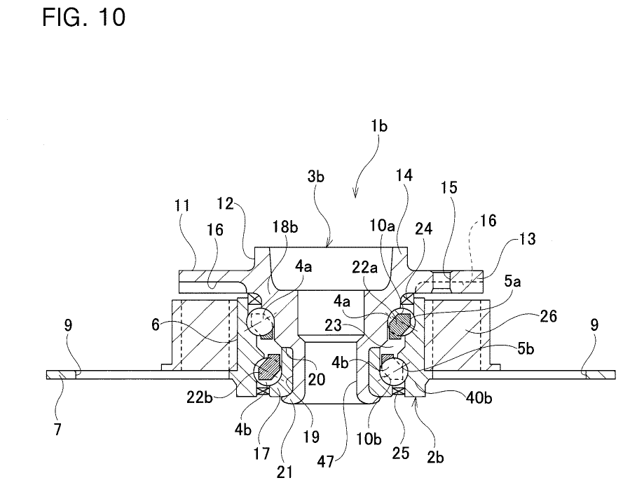

FIG. 10 illustrates a rotation support device for flying object of a third example of an embodiment of the present disclosure.

The rotation support device 1b for flying object of the present example has a different-diameter PCD type structure in which pitch circle diameters of the rolling elements of both rows differ from each other. Specifically, the pitch circle diameter of the rolling elements 4a of a row on the first side in the axial direction is larger than that of the rolling elements 4b of a row on the second side in the axial direction. That is, in the stationary side support member 40b of the stationary body 2b, the diameter of the outer ring raceway 5a on the first side in the axial direction is larger than the diameter of the outer ring raceway 5b on the second side in the axial direction. Further, in the inner ring 17 and the rotating side support member 18b of the rotating body 3b, the diameter of the inner ring raceway 10a on the first side in the axial direction is made larger than the diameter of the inner ring raceway 10b on the second side in the axial direction. Compared to the equal-diameter PCD type structure of the first example, the different-diameter PCD type structure of the present example provides higher rigidity with respect to the torque generated by the rotation of the propeller 31 (see FIG. 1).

Other configurations and effects of the third example are the same as those of the first example.

### Fourth Example

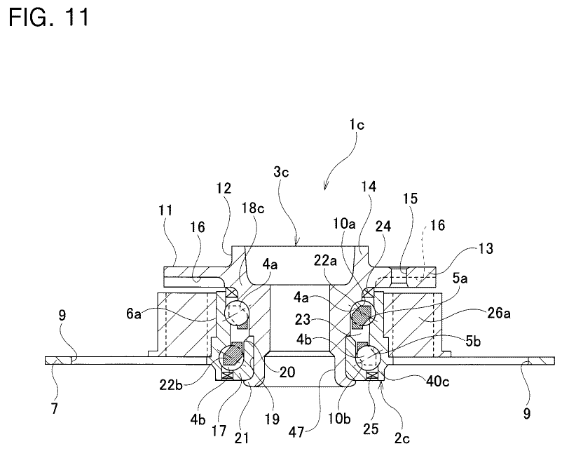

FIG. 11 illustrates a rotation support device for flying object of a fourth example of an embodiment of the present disclosure.

The rotation support device 1c for flying object of the present example has a different-diameter PCD type structure in which pitch circle diameters of rolling elements of both rows differ from each other. Specifically, the pitch circle diameter of the rolling elements 4b in a row on the second side in the axial direction is larger than the pitch circle diameter of the rolling elements 4a in a row on the first side in the axial direction. That is, in the stationary side support member 40c of the stationary body 2c, the diameter of the outer ring raceway 5b on the second side in the axial direction is made larger than the diameter of the outer ring raceway 5a on the first side in the axial direction. Further, in the inner ring 17 and the rotating side support member 18c of the rotating body 3c, the diameter of the inner ring raceway 10b on the second side in the axial direction is made larger than the diameter of the inner ring raceway 10a on the first side in the axial direction.

Furthermore, in the present example, the stationary fitting portion 6a of the stationary side support member 40c has a stepped cylindrical shape in which an outer diameter of a portion on the second side in the axial direction that overlaps in the radial direction with the outer ring raceway 5b on the second side in the axial direction is larger than an outer diameter of a portion on the first side in the axial direction that overlaps in the radial direction with the outer ring raceway 5a on the first side in the axial direction. By adopting such a configuration, a thickness in the radial direction of the portions of the stationary side support member 40c where the outer ring raceways 5a, 5b are located are made approximately equal to each other, thereby reducing the weight of the stationary side support member 40c. In this example, the inner circumferential surface of an annular member 26a that fits onto the stationary fitting portion 6a also has a stepped cylindrical shape that matches the stationary fitting portion 6a. Compared to the equal-diameter PCD type structure of the first example, the different-diameter PCD type structure of the present example can stably fix the motor stator 33 (see FIG. 1), thereby enabling coaxiality between the motor stator 33 and the motor rotor 34 (see FIG. 1) higher.

Other configurations and effects of the fourth example are the same as those of the first example.

### Fifth Example

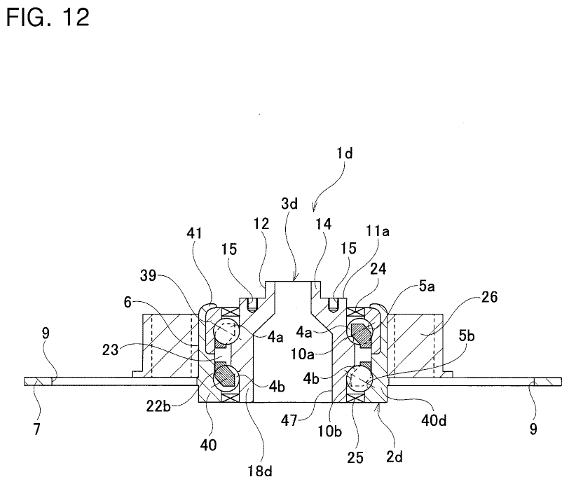

FIG. 12 illustrates a rotation support device for flying object of a fifth example of an embodiment of the present disclosure.

In the rotation support device Id for flying object of the present example, only an outer ring raceway 5b on the second side in the axial direction of the pair of double-row outer ring raceways 5a, 5b is directly formed on an inner circumferential surface of a stationary body 2d. Specifically, the stationary body 2d is configured by a stationary side support member 40d and an outer ring 39 fitted into the stationary side support member 40d. The inner circumferential surface of the stationary body 2d includes an inner circumferential surface of the stationary side support member 40d and an inner circumferential surface of the outer ring 39. The outer ring raceway 5a on the first side in the axial direction is formed on the inner circumferential surface of the outer ring 39, and the outer ring raceway 5b on the second side in the axial direction is directly formed on the inner circumferential surface of the stationary side support member 40.

In the present example, the stationary fitting portion 6 and the stationary flange 7 are provided on the stationary side support member 40d. The outer ring 39 is fitted into a portion on the first side in the axial direction of the stationary side support member 40d and is connected and fixed to the stationary side support member 40d by being pressed at an end surface on the first side in the axial direction by a crimped portion 41 provided at an end portion on the first side in the axial direction of the stationary side support member 40d.

The stationary side support member and the outer ring may also be connected by screwing a nut onto an inner circumferential surface of a portion of the stationary side support member that protrudes further in the axial direction than the outer ring.

In the present example, double-row inner ring raceways 10a, 10b are directly formed on an outer circumferential surface of a rotating body 3d. Specifically, the rotating body 3d consists of a rotating side support member 18d, and the double-row inner ring raceways 10a, 10b are formed on an outer circumferential surface of the rotating side support member 18d.

In the present example, the rotating side support member 18d does not include a rotating flange and has a rotor contact portion 11a in a peripheral portion around a pilot portion 14 of an end surface on the first side in the axial direction. The rotating side support member 18d has mounting holes 15 that each opens to the rotor contact portion 11a at a plurality of locations in the circumferential direction. Since the rotating side support member 18d does not have a rotating flange in the structure of this example, it contributes to reducing the weight.

In the present example, rolling elements 4a, 4b arranged in double rows are provided with a contact angle of face-to-face arrangement (DF) and a predetermined amount of preload.

In the present example, the outer ring 39 has a groove shoulder portion on the inner circumferential surface in a portion adjacent to the first side in the axial direction of the outer ring raceway 5a on the first side in the axial direction. The groove shoulder portion has an inner diameter smaller than a portion adjacent to the second side in the axial direction of the outer ring raceway 5a. The stationary side support member 40d has a groove shoulder portion on the inner circumferential surface in a portion adjacent to the second side in the axial direction of the outer ring raceway 5b on the second side in the axial direction. The groove shoulder portion has an inner diameter smaller than a portion adjacent to the first side in the axial direction of the outer ring raceway 5b.

In the present example, the rotating side support member 18d has a groove shoulder portion on the outer circumferential surface in a portion adjacent to the second side in the axial direction of the inner ring raceway 10a on the first side in the axial direction. The groove shoulder portion has an outer diameter larger than a portion adjacent to the first side in the axial direction of the inner ring raceway 10a. The rotating side support member 18d has a groove shoulder portion on the outer circumferential surface in a portion adjacent to the first side in the axial direction of the inner ring raceway 10b on the second side in the axial direction. The groove shoulder portion has an outer diameter larger than a portion adjacent to the second side in the axial direction of the inner ring raceway 10b.

Since the DF-type structure of the present example can reduce the preload compared to the DB-type structure of the first example when the pitch circle diameter of the rolling elements 4a, 4b is the same, it is possible to reduce the amount of heat generated at a rolling contact portion and to facilitate cooling.

Other configurations and effects of the fifth example are the same as those of the first example.

### Sixth Example

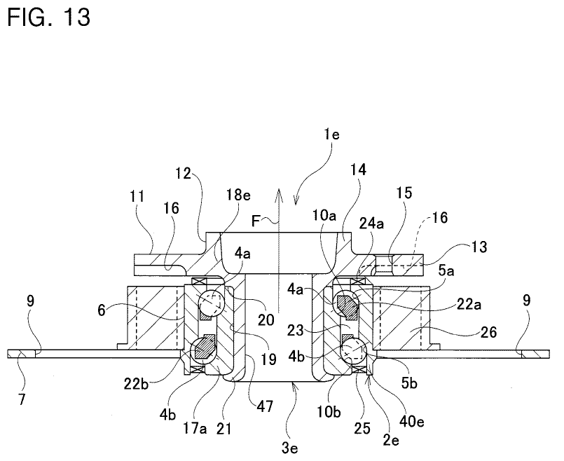

FIG. 13 illustrates a rotation support device for flying object of a fifth example of an embodiment of the present disclosure.

In a rotation support device le for flying object of the present example, a rotating body 3e is configured by a rotating side support member 18e and an inner ring 17a externally fitted to the rotating side support member 18e, and double-row inner ring raceways 10a, 10b are formed on an outer circumferential surface of the inner ring 17a.

In the rotation support device le for flying object of the present example, rolling elements 4a, 4b arranged in double rows are provided with a contact angle of a parallel combination arrangement (DT).

The direction of the contact angle is a direction in which, when an axial load F is applied to the rotating body 3e in a direction toward the first side in the axial direction with respect to a stationary body 2e, the axial load F can be supported. For this reason, in the present example, a stationary side support member 40e of the stationary body 2e has a groove shoulder portion on an inner circumferential surface in a portion adjacent to the first side in the axial direction of each of the outer ring raceways 5a, 5b. The groove shoulder portion has an inner diameter smaller than a portion adjacent to the second side in the axial direction of the outer ring raceways 5a, 5b. Further, the inner ring 17a of the rotating body 3e has a groove shoulder portion on an outer circumferential surface in a portion adjacent to the second side in the axial direction of each of the inner ring raceways 10a, 10b. The groove shoulder portion has an outer diameter larger than a portion adjacent to the first side in the axial direction of the inner ring raceways 10a, 10b.

In the structure of the present example, when the propeller 31 (see FIG. 1) rotates and a lifting force F is applied to the rotating body 3e, the lifting force can be efficiently supported by the double rows of rolling elements 4a, 4b.

In the present example, a first-side seal device 24a is configured by an annular rubber member fixed to an end surface on the first side in the axial direction of the stationary side support member 40e.

In the present example, when the propeller 31 rotates and the lifting force F is applied to the rotating body 3e as illustrated in FIG. 13, a labyrinth gap in the axial direction is interposed between a side surface on the first side in the axial direction of the seal device 24a on the first side and a side surface on the second side in the axial direction of the rotating flange 13. That is, in this state, the seal device 24a on the first side functions as a non-contact seal. Therefore, the rotational resistance of the rotating body 3e can be kept small.

In the present example, when the rotation of the propeller 31 stops and the lifting force F applied to the rotating body 3e disappears, the rotating body 3e is displaced downward relative to the stationary body 2e, and a side surface on the second side in the axial direction of the rotating flange 13 comes into contact with a side surface on first side in the axial direction of the first-side seal device 24a, so that the rotating body 3e is supported by the seal device 24a on the first side. In this state, the first-side seal device 24a functions as a contact seal.

Other configurations and effects of the sixth example are the same as those of the first example.

### Seventh Example

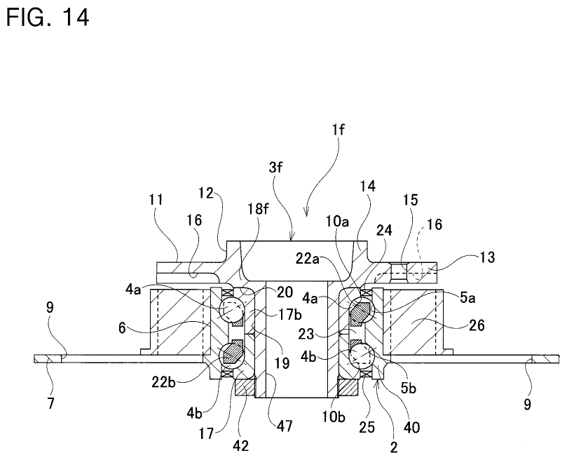

FIG. 14 illustrates a rotation support device for flying object of a seventh example of an embodiment of the present disclosure.

In a rotation support device If for flying object of the present example, the rotating body 3f further includes an inner ring 17b having an inner ring raceway 10a on the first side in the axial direction formed on an outer circumferential surface thereof. The inner ring 17b is externally fitted onto a small-diameter stepped portion 19 of a rotating side support member 18f. Further, in the present example, a pair of inner rings 17, 17b are connected and fixed to the rotating side support member 18f by being held in the axial direction between a nut 42 screwed onto an end portion on the second side in the axial direction of the rotating side support member 18f and a stepped surface 20 of the rotating side support member 18f.

Other configurations and effects of the seventh example are the same as those of the first example.

### Eighth Example

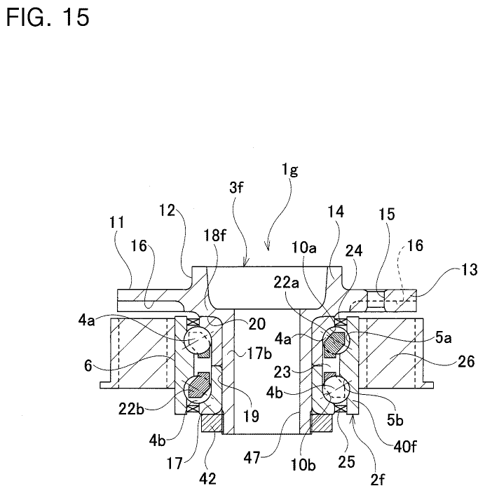

FIG. 15 illustrates a rotation support device for flying object of an eighth example of an embodiment of the present disclosure.

In a rotation support device 1g for flying object of the present example, a stationary side support member 40f of a stationary body 2f does not have a stationary flange. In the present example, the stationary body 2f is supported and fixed to an airframe by having an end portion on the second side in the axial direction fitted into or held by the airframe.

Other configurations and effects of the eighth example are the same as those of the seventh example.

### Ninth Example

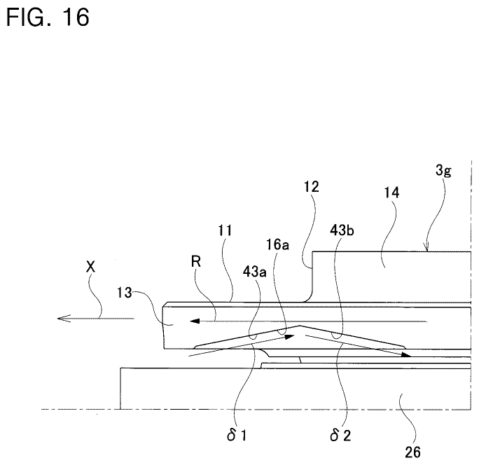

FIG. 16 illustrates a rotation support device for flying object of a ninth example of an embodiment of the present disclosure.

At least part of a bottom surface in the axial direction of each of flange recess portions 16a provided in a rotating flange 13 can be formed by an inclined surface inclined with respect to an imaginary flat plane perpendicular to the axial direction (vertical direction in FIG. 16) of a rotating body 3g. In the present example, the entire bottom surface is formed by an inclined surface, and the bottom surface is configured by a pair of inclined surfaces 43a, 43b that are inclined in a direction toward the second side in the axial direction (downward in FIG. 16) as going from a central portion in the circumferential direction toward both sides in the circumferential direction.

In the present example, when the rotating body 3g rotates together with the propeller 31 (see FIG. 1), airflows are generated in the directions of the arrows α, β, and γ (see FIG. 1) as in the first example. In addition, airflows 81 and 82 in the circumferential direction opposite to the rotational direction R are generated along the pair of inclined surfaces 43a and 43b.

That is, of the pair of inclined surfaces 43a, 43b, the inclined surface 43a located on the front side (left side in FIG. 16) with respect to the rotational direction R is inclined in a direction toward the first side in the axial direction (upper side in FIG. 16) as going toward the rear side (right side in FIG. 16) with respect to the rotational direction R. Therefore, the airflow 81 generated along the inclined surface 43a also flows in the direction toward the first side in the axial direction as going toward the rear side with respect to the rotational direction R.

Further, of the pair of inclined surfaces 43a, and 43b, the inclined surface 43b located on the rear side (right side in FIG. 16) with respect to the rotational direction R is inclined in a direction toward the second side in the axial direction (lower side in FIG. 16) as going toward the rear side with respect to the rotational direction R. Therefore, the airflow 82 generated along the inclined surface 43b also flows in the direction toward the second side in the axial direction as going toward the rear side with respect to the rotational direction R.

Furthermore, the airflows 81, 82 in FIG. 16 are also generated by air flowing to the right in FIG. 16 around the flying object as it moves when the traveling direction X of the flying object is to the left in FIG. 16.

Since the airflow 82 has a component in the direction toward the second side in the axial direction, it hits the annular member 26. As a result, heat dissipation of the annular member 26 is promoted, and cooling of the drive motor 32 (see FIG. 1) is promoted.

As an alternative example in the structure in which at least part of the bottom surface in the axial direction of each of the flange recess portions is configured by an inclined surface inclined with respect to an imaginary flat plane perpendicular to the axial direction of the rotating body, a structure may also be adopted in which at least part of the bottom surface in the axial direction of each of the flange recess portions is configured by an inclined surface inclined in a direction toward the second side in the axial direction as going toward the rear side in the rotational direction of the rotating body. In this case, the entire bottom surface in the axial direction of each of the flange recess portions may be configured by the inclined surface.

Other configurations and effects of the nineth example are the same as those of the first example.

### Tenth Example

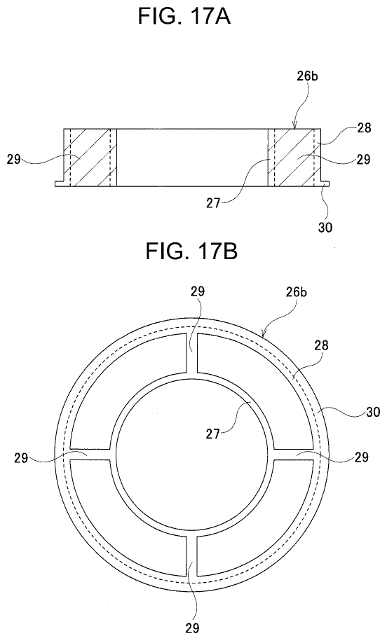

The rotation support device for flying object of a tenth example of an embodiment of the present disclosure will be described with reference to FIG. 17.

In the rotation support device for flying object of the present example, the structure of part of an annular member 26b that is externally fitted onto the stationary side support member 40 (see FIG. 1) differs from that of the annular member 26 (see FIG. 1) of the rotation support device 1 for flying object of the first example.

Specifically, the annular member 26b of the present example has fewer connecting portions 29 than the annular member 26 of the first example, and in the illustrated example, there are four connecting portions 29. In a case of implementing the rotation support device for flying object of the present disclosure, the number of connecting portions of the annular member may be different from that of the present example and the first example, as long as the required strength of the annular member can be ensured.

In the present example, the number of connecting portions 29 provided on the annular member 26b is less than in the structure of the first example, resulting in lower heat dissipation performance. However, the annular member 26b can be configured to be lightweight, thereby contributing to reducing the overall weight of the rotation support device for flying object.

Other configurations and effects of the tenth example are the same as those of the first example.

### Eleventh Example

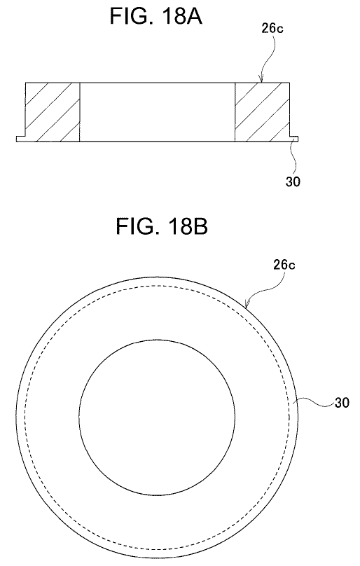

The rotation support device for flying object of an eleventh example of an embodiment of the present disclosure will be described with reference to FIG. 18.

In the rotation support device for flying object of the present example, part of the structure of an annular member 26c that is externally fitted onto the stationary side support member 40 (see FIG. 1) differs from the annular member 26 (see FIG. 1) of the rotation support device 1 for flying object of the first example.

Specifically, compared to the annular member 26 of the first example, the annular member 26c of the present example has a structure that does not have ventilation passages in the axial direction in a middle portion in the radial direction, in other words, the ventilation passages have a structure filled with the material making the annular member 26c.

In the present example, since the annular member 26c does not have ventilation passages in the axial direction in a middle portion in the radial direction, it is easier to ensure the strength and rigidity of the annular member 26c.

Other configurations and effects of the eleventh example are the same as those of the first example.

### Twelfth Example

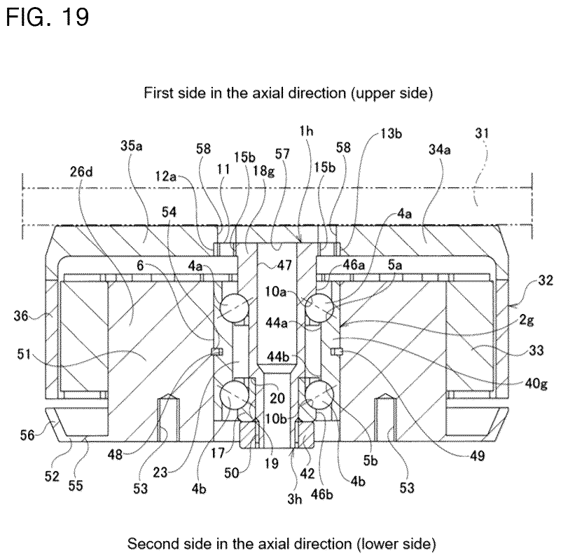

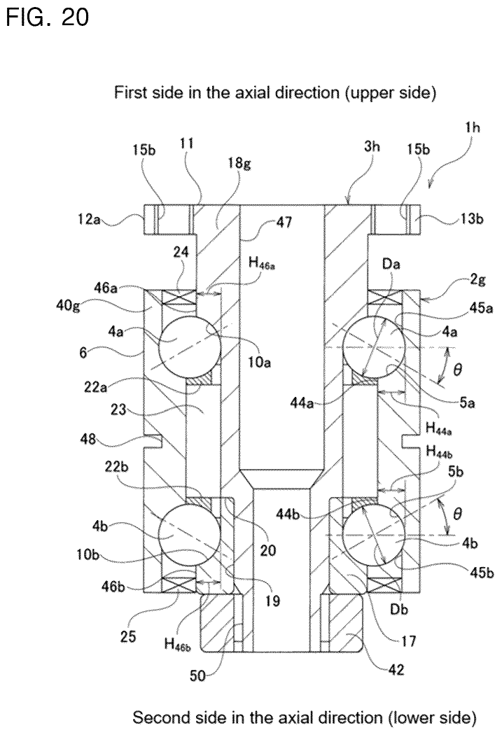

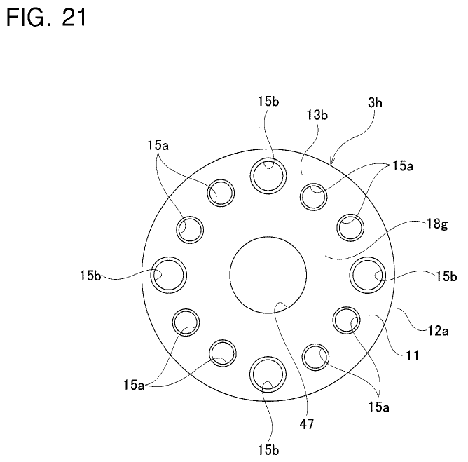

The rotation support device for flying object of a twelfth example of an embodiment of the present disclosure will be described with reference to FIG. 19 to FIG. 21.

In the rotation support device 1h for flying object of the present example, the stationary body 2g does not have a stationary flange that protrudes from a stationary side support member 40g toward the outside in the radial direction. A stationary fitting portion 6 provided on the outer circumferential surface of the stationary side support member 40g has an inner diameter side engaging groove 48 over the entire circumference at a middle portion in the axial direction. The inner diameter side engaging groove 48 has a substantially rectangular cross-sectional shape. The inner diameter side engaging groove 48 is used to engage an inner side portion in the radial direction of a partially ring-shaped retaining ring 49 that is bridged between the motor stator 33 or an annular member 26d (annular member 26d in this example), which is externally fitted to the stationary fitting portion 6, and the stationary side support member 40g.

In the present example, the stationary body 2g (stationary side support member 40g) is supported and fixed to an airframe of a flying object through the annular member 26d.

In the present example, a rotating flange 13b provided at an end portion on the first side in the axial direction of a rotating side support member 18g of the rotating body 3h is formed in a hollow circular flat plate shape.

The rotating flange 13b has mounting holes 15a penetrating in the axial direction at a plurality of locations in the circumferential direction, and has mounting holes 15b penetrating in the axial direction at a plurality of locations in the circumferential direction spaced from the mounting holes 15a. The mounting holes 15a are used to connect and fix the propeller 31 to the rotating flange 13b. In the present example, the mounting holes 15a are configured by screw holes. The mounting holes 15b are used to connect and fix the motor rotor 34a to the rotating flange 13b. In the present example, the mounting holes 15b are configured by screw holes.

The outer diameter of the rotating flange 13b is equal to or smaller than the outer diameter of the stationary fitting portion 6 of the stationary body 2g, and specifically, is the same size as the outer diameter of the stationary fitting portion 6.

In the present example, the rotating side support member 18g has a male screw portion 50, to which a nut 42 is screwed, on a portion adjacent to the second side in the axial direction of the small-diameter stepped portion 19.

In the present example, the rotating body 3h is configured by externally fitting the inner ring 17 to the small-diameter stepped portion 19 of the rotating side support member 18g and by connecting and fixing the rotating side support member 18g and the inner ring 17 by holding the inner ring 17 from both sides in the axial direction between the stepped surface 20 of the rotating side support member 18g and a side surface on the first side in the axial direction of the nut 42 screwed onto the male screw portion 50 of the rotating side support member 18g. In the rotation support device 1h for flying object of the present example, the rotating body 3h is configured by connecting and fixing the rotating side support member 18g and the inner ring 17, so that a preload applied to the rolling elements 4a, 4b can be adjusted to an appropriate magnitude.

In the present example, the annular member 26d includes a main body portion 51 and a cover portion 52.

The main body portion 51 is a portion that is externally fitted onto the stationary fitting portion 6 of the stationary side support member 40g, and is configured into a cylindrical shape. In the present example, the main body portion 51 has an axial dimension that is slightly larger than the axial dimension of the stationary side support member 40g. The main body portion 51 has a structure that makes it easy to ensure a large contact area with the surrounding air. Specifically, the main body portion 51 has ventilation passages (not illustrated) at a plurality of locations in the circumferential direction, each of which is capable of passing air in the axial direction. A portion of the main body portion 51 located between adjacent ventilation passages in the circumferential direction functions as a heat dissipation fin portion.

The main body portion 51 has support holes 53 that open only to the second side in the axial direction at a plurality of locations in the circumferential direction at an end portion on the second side in the axial direction, spaced from the ventilation passages. The support holes 53 are configured by screw holes and are used to connect and fix the annular member 26d to the airframe of the flying object.

The main body portion 51 has an outer diameter side engaging groove 54 at a middle portion in the axial direction of the inner circumferential surface over the entire circumference. The outer diameter side engaging groove 54 is used to engage an outer side portion in the radial direction of the regaining ring 49.

The cover portion 52 has an axial cover portion 55 which has a hollow circular flat plate shape that extends from an end portion on the second side in the axial direction of the outer circumferential surface of the main body portion 51 toward the outside in the radial direction, and a radial cover portion 56 which extends from an outer end portion in the radial direction of the axial cover portion 55 toward the outside in the radial direction and toward the first side in the axial direction.

In the present example, the annular member 26d is fixed to the stationary side support member 40g by press-fitting the main body portion 51 onto the stationary fitting portion 6 of the stationary side support member 40g. Further, the inner side portion in the radial direction of the retaining ring 49 is engaged with the inner diameter side engaging groove 48 of the stationary side support member 40g, and the outer side portion in the radial direction of the retaining ring 49 is engaged with the outer diameter side engaging groove 54 of the annular member 26d. As a result, the stationary side support member 40g and the annular member 26d are positioned in the axial direction, and relative displacement in the axial direction between the stationary side support member 40g and the annular member 26d is prevented.

In this state, a side surface on the first side in the axial direction of the main body portion 51 of the annular member 26d is arranged at the same position in the axial direction as an end surface on the first side in the axial direction of the stationary side supporting member 40g, and a side surface on the second side in the axial direction of the main body portion 51 of the annular member 26d is arranged at a position protruding further toward the second side in the axial direction than an end surface on the second side in the axial direction of the stationary side supporting member 40g.

When externally fitting and fixing the annular member 26d onto the stationary fitting portion 6 of the stationary side supporting member 40g, the retaining ring 49 is elastically contracted, and with the entire retaining ring 49 housed inside the inner diameter side engaging groove 48, the main body portion 51 of the annular member 26d is press-fitted onto the stationary fitting portion 6. This causes the retaining ring 49 to enter the inner side in the radial direction of the main body portion 51. Then, when the inner diameter side engaging groove 48 and the outer diameter side engaging groove 54 face each other in the radial direction, the retaining ring 49 is elastically expanded, and the outer side portion in the radial direction of the retaining ring 49 is engaged with the outer diameter side engaging groove 54.

The stationary side supporting member 40g is supported and fixed to the airframe by screwing bolts, which are connecting members inserted into through holes provided on the airframe of the flying object, into the support holes 53 of the annular member 26d, which is externally fitted and fixed to the stationary fitting portion 6 of the stationary side supporting member 40g, from the second side in the axial direction.

In the present example, a side plate portion 35a of the motor rotor 34a has a concave portion 57 at central portion in the radial direction of a side surface on the second side in the axial direction, into which the rotating flange 13b of the rotating body 3h can be fitted without looseness in the radial direction. In the present example, a rotor fitting portion 12a is configured by the outer circumferential surface of the rotating flange 13b.

The motor rotor 34a is positioned in the radial and axial directions with respect to the rotor 3h by fitting the rotating flange 13b into the concave portion 57 of the side plate portion 35a without looseness in the radial direction so as to externally fit a cylindrical shaped inner circumferential surface configuring the inner surface of the concave portion 57 onto a rotor fitting portion 12a configured by an outer circumferential surface of the rotating flange 13b and by bringing a bottom surface of the concave portion 57 into contact with a rotor contact portion 11 configured by a side surface on the first side in the axial direction of the rotating flange 13b. Furthermore, in this state, the motor rotor 34a is connected and fixed to the rotating flange 13b by screwing bolts (not illustrated) inserted into the through holes 58 provided at a plurality of locations in the circumferential direction at an inner side portion in the radial direction of the side plate portion 35a into mounting holes 15b of the rotating flange 13b.

The propeller 31 is connected and fixed the rotating flange 13b with the central axis of rotation of the propeller 31 aligned with the central axis of the rotating body 3h and a side surface on the second side in the axial direction of a peripheral portion around the central axis of rotation of the propeller 31 brought into contact with a side surface on the first side in the axial direction of the side plate portion 35a, by screwing bolts inserted into through holes (not illustrated) provided at a plurality of locations in the circumferential direction of the propeller 31 and inserted into through holes (not illustrated) provided at a plurality of locations in the circumferential direction of the side plate portion 35a, into the mounting holes 15b of the rotating flange 13b.

The structure for connecting the motor rotor and the propeller to the rotating body is not limited to the structure of the present example, and various structures can be adopted. For example, the mounting holes of the rotating flange provided at an end portion on the first side in the axial direction of the rotating body is configured by press-fit holes, and the motor rotor and the propeller can be connected and fixed to the rotating flange with stud bolts press-fitted into the press-fit holes being inserted into into through holes of a side plate portion of the motor rotor and through holes of the propeller, by screwing nuts onto tip end portions of the stud bolts.

In the rotation support device 1h for flying object of the present example, a plurality of rolling elements 4a, 4b configured by balls, are respectively arranged between the double-row outer ring raceways 5a, 5b and the double-row inner ring raceways 10a, 10b in a state where a back-to-back arrangement (DB) contact angle is applied, and a groove shoulder height H₄₄ₐ on a load side of the outer ring raceway 5a on the first side in the axial direction is 25% or more of a diameter Da of the rolling elements 4a of the row on the first side in the axial direction, a groove shoulder height H_{44b} on a load side of the outer ring raceway 5b on the second side in the axial direction is 25% or more of a diameter Db of the rolling elements 4b of the row on the second side in the axial direction, a groove shoulder height H₄₆ₐ on a load side of the inner ring raceway 10a on the first side in the axial direction is 25% or more of the diameter Da of the rolling elements 4a of the row on the first side in the axial direction, and a groove shoulder height H_{46b} on a load side of the inner ring raceway 10b on the second side in the axial direction is 25% or more of the diameter Db of the rolling elements 4b of the row on the second side in the axial direction.

Therefore, with such a configuration, the rotation support device 1h for flying object of the present example also makes it possible to appropriately ensure moment rigidity and axial load bearing capacity while suppressing an increase in weight.

Other configurations and effects of the twelfth example are the same as those of the first example.

### Thirteenth Example

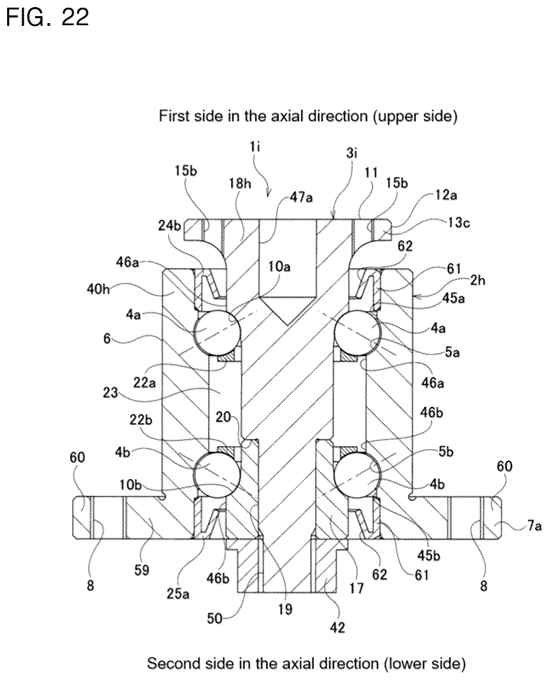

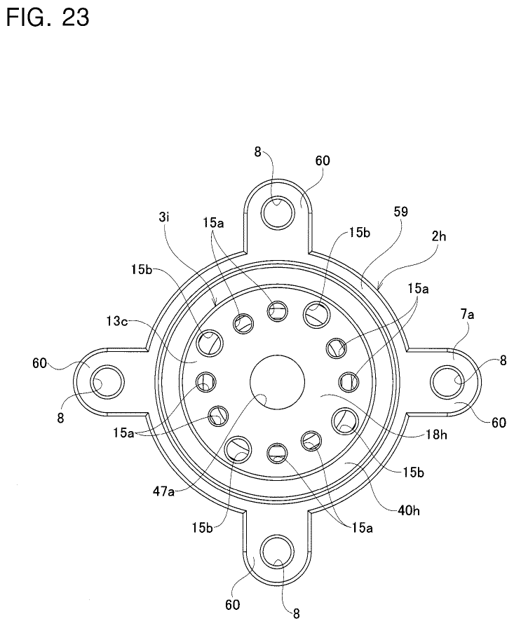

The rotation support device for flying object of a thirteenth example of an embodiment of the present disclosure will be described with reference to FIG. 22 to FIG. 23.

In the rotation support device li for flying object of the present example, a stationary side support member 40h of a stationary body 2h has a stationary flange 7a protruding toward the outside in the radial direction at an end portion on the second side in the axial direction, which is a portion located further to the second side in the axial direction than the stationary fitting portion 6. The stationary flange 7a has support holes 8 penetrating in the axial direction at a plurality of locations in the circumferential direction (four locations in the illustrated example). In the present example, the support holes 8 are configured by screw holes.

In the present example, the stationary flange 7a includes a hollow circular stationary flange base portion 59 that configures an inner end portion in the radial direction of the stationary flange 7a, and stationary flange pieces 60 that configure middle portions and outer end portions in the radial direction of the stationary flange 7a and extend toward the outside in the radial direction from a plurality of locations in the circumferential direction (in the illustrated example, four locations that are uniformly spaced in the circumferential direction) of the stationary flange base portion 59. One support hole 8 is provided in each of the stationary flange pieces 60. In the present example, the outer side portion in the radial direction of each stationary flange piece 60 has a semicircular shape centered on a central axis of the support hole 8 when viewed from the axial direction.

In the present example, since the middle portion and outer end portion in the radial direction of the stationary flange 7a are configured by a plurality of stationary flange pieces 60 arranged so as to be spaced from each other in the circumferential direction, it is easier to reduce the weight of the stationary side support member 40h compared to a case where the entire stationary flange is connected over the entire circumference. However, it is also possible to adopt a configuration in which the entire stationary flange is continuous over the entire circumference.

The stationary side support member 40h is supported and fixed to an airframe of a flying object by screwing bolts, which are connecting members inserted into through holes provided on the airframe, into the support holes 8 of the stationary flange 7a from the second side in the axial direction.

In the present example, an annular member (not illustrated) is externally fitted to and supported on a stationary fitting portion 6 of the stationary-side support member 40h in the same manner as in the first example.

In the present example, the outer diameter of the rotating flange 13c of the rotating side support member 18h of the rotating body 3i is smaller than the outer diameter of the stationary fitting portion 6.

In the present example, a central hole 47a provided in the rotating side support member 18h is configured by a bottomed hole that opens only to an end surface on the first side in the axial direction of the rotating side support member 18h.

In the present example, non-contact seals are employed as the first-side seal device 24b that closes an opening on the first side in the axial direction of the rolling element installation space 23, and as the second-side seal device 25a that closes an opening on the second side in the axial direction of the rolling element installation space 23.

Specifically, each of the first-side seal device 24b and the second-side seal device 25a is made of a metal plate such as a steel sheet, and includes a fitting tubular portion 61 and a side plate portion 62. The fitting tubular portions 61 are internally fitted with an interference fit to inner circumferential surfaces at end portions on both sides in the axial direction of the stationary support member 40h. The side plate portion 62 is bent toward the inner side in the radial direction from an end portion on the external space side in the axial direction of the fitting tubular portion 61 and extends toward the inner side in the radial direction, with an inner end portion in the radial direction thereof closely facing the outer circumferential surface of the rotating body 3i. The side plate portion 62 is formed into a conical cylindrical shape inclined in a direction toward the center side in the axial direction of the rolling element installation space 23 as going toward the inner side in the radial direction.

In the present example, since non-contact type seal devices are employed as the first-side seal device 24b and the second-side seal device 25a, it is possible to prevent sliding resistance (seal torque) from being generated at installation portions of the first-side seal device 24b and the second-side seal device 25a. Accordingly, it is possible to prevent an increase in torque (rotational resistance) of the rotation support device li for flying object.

Other configurations and effects of the thirteenth example are the same as those of the twelfth example.

The rotation support device for flying object according of the present disclosure can be implemented by appropriately combining the structures of the embodiments described above within a range that does not cause contradictions.

### REFERENCE SIGNS LIST

1, 1a, 1b, 1c, 1d, le, 1f, 1g, 1h, li Rotation support device for flying object
2, 2a, 2b, 2c, 2d, 2e, 2f, 2g, 2h Stationary body
3, 3a, 3b, 3c, 3d, 3e, 3f, 3g, 3h, 3i Rotating body
4a, 4b Rolling elements
5a, 5b Outer ring raceways
6, 6a Stationary fitting portion
7, 7a Stationary flange
8 Support holes
9 Window holes
10a, 10b Inner ring raceways
11, 11a Rotor contact portion
12, 12a Rotor fitting portion
13, 13a, 13b, 13c Rotating flange
14 Pilot portion
15, 15a, 15b Mounting holes
16, 16a Flange recess portions
17, 17a, 17b Inner ring
18, 18a, 18b, 18c, 18d, 18e, 18f, 18g, 18h Rotating side support member
19 Small-diameter stepped portion
20 Stepped surface
21 Crimped portion
22a, 22b Cages
23 Rolling element installation space
24, 24a, 24b First-side seal device
25, 25a Second-side seal device
26, 26a, 26b, 26c, 26d Annular member
27 Inner diameter side cylindrical portion
28 Outer diameter side cylindrical portion
29 Connecting portions
30 Outward flange portion
31 Propeller
32 Drive motor
33 Motor stator
34, 34a Motor rotor
35, 35a Side plate portion
36 Tubular portion
37 Ventilation holes
38 Bearing cap
39 Outer surface
40, 40a, 40b, 40c, 40d, 40e, 40f, 40g, 40h Stationary side support member
41 Crimped portion
42 Nut
43a, 43b Inclined surface
44a, 44b Groove shoulder portion
45a, 45b Counterbore portion
46a, 46b Groove shoulder portion
47, 47a Central hole
48 Inner diameter side engaging groove
49 Regaining ring
50 Male screw portion
51 Main body portion
52 Cover portion
53 Support holes
54 Outer diameter side engaging groove
55 Axial cover portion
56 Radial cover portion
57 Recess portions
58 Through holes
59 Stationary flange base portion
60 Stationary flange pieces
61 Fitting tubular portions
62 Side plate portion

1. A rotation support device for flying object, comprising:
a stationary body having double-row outer ring raceways on an inner circumferential surface thereof and capable of supporting a motor stator,
a rotating body having double-row inner ring raceways on an outer circumferential surface and capable of supporting a motor rotor and a propeller, and
a plurality of rolling elements arranged between the double-row outer ring raceways and the double-row inner ring raceways so as to be able to roll freely, and
at least one outer ring raceway of the double-row outer ring raceways directly formed on the inner circumferential surface of the stationary body, and/or at least one inner ring raceway of the double-row inner ring raceways directly formed on the outer circumferential surface of the rotating body.

2. The rotation support device for flying object according to claim 1, wherein
the stationary body has a stationary fitting portion on an outer circumferential surface thereof onto which the motor stator or an annular member onto which the motor stator is fitted, is able to be fitted.

3. The rotation support device for flying object according to claim 1, wherein
the rotating body has, at a portion located further to a first side in an axial direction than the stationary body, a rotor contact portion with which a mounting portion of the motor rotor to the rotating body is able to axially come into contact, and a rotor fitting portion onto which the mounting portion of the motor rotor is able to be fitted.

4. The rotation support device for flying object according to claim 3, wherein the rotating body has a rotating flange protruding toward an outside in a radial direction at the portion located further to the first side in the axial direction than the stationary body, and the rotor contact portion is configured by a side surface on the first side in the axial direction of the rotating flange.

5. The rotation support device for flying object according to claim 4, wherein
the stationary body has a stationary fitting portion on an outer circumferential surface thereof onto which the motor stator or an annular member onto which the motor stator is fitted, is able to be fitted, and an outer diameter of the rotating flange is equal to or less than an outer diameter of the stationary fitting portion.

6. The rotation support device for flying object according to claim 4, wherein
the rotating flange has flange recess portions that open to a second side in the axial direction and to the outside in the radial direction at a plurality of locations in a circumferential direction.

7. The rotation support device for flying object according to claim 3, wherein
the rotating body has a pilot portion at an end portion on the first side in the axial direction, and the rotor fitting portion is configured by an outer circumferential surface of the pilot portion.

8. The rotation support device for flying object according to claim 2, wherein
the stationary body has a stationary flange protruding toward an outside in a radial direction at a portion located further to a second side in an axial direction of the stationary fitting portion.

9. The rotation support device for flying object according to claim 8, wherein
the stationary flange has window holes penetrating in the axial direction at a plurality of locations in a circumferential direction thereof.

10. The rotation support device for flying object according to claim 2,
the rotation support device including an annular member fitted onto the stationary fitting portion of the stationary body.

11. The rotation support device for flying object according to claim 10, wherein
the rotating body has a rotating flange protruding toward an outside in a radial direction at the portion located further to the first side in the axial direction than the stationary body, and a rotor contact portion with which a mounting portion of the motor rotor to the rotating body is able to axially come into contact, is configured by a side surface on the first side in the axial direction of the rotating flange, and an outer diameter of the rotating flange is equal to or less than an outer diameter of the annular member.

12. The rotation support device for flying object according to claim 1,
the rotation support device including a first-side seal device that closes an opening on a first side in an axial direction of a rolling element installation space that exists between the inner circumferential surface of the stationary body and the outer circumferential surface of the rotating body.

13. The rotation support device for flying object according to claim 1,
the rotation support device including a second-side seal device that closes an opening on a second side in an axial direction of a rolling element installation space that exists between the inner circumferential surface of the stationary body and the outer circumferential surface of the rotating body.

14. The rotation support device for flying object according to claim 1,
the rotation support device including a bearing cap that closes an opening at an end portion on a second side in an axial direction of the stationary body.

15. The rotation support device for flying object according to claim 1, wherein
the double-row outer ring raceways respectively has an arc-shaped cross-sectional shape,
the double-row inner ring raceways respectively has an arc-shaped cross-sectional shape,
the plurality of rolling elements are balls arranged between the double-row outer ring raceways and the double-row inner ring raceways with a back-to-back arrangement contact angle applied, and
a groove shoulder height on a load side of the outer ring raceways and a groove shoulder height on a load side of the inner ring raceways are 25% or more of a diameter of the balls in each row.

16. The rotation support device for flying object according to claim 1, wherein
the stationary body consists of a stationary side support member having the double-row outer ring raceways directly formed on the inner circumferential surface thereof, and
the rotating body includes a rotating side support member having an inner ring raceway on a first side in an axial direction of the double-row inner ring raceways directly formed on an outer circumferential surface of the rotating side support member, and an inner ring having an inner ring raceway on a second side in the axial direction of the double-row inner ring raceways directly formed on an outer circumferential surface of the inner ring, the inner ring fitted onto the rotating side support member.

17. The rotation support device for flying object according to claim 2, wherein
the stationary fitting portion has an inner diameter side engaging groove to which an inner side portion in a radial direction of a retaining ring is able to be engaged, the retaining ring bridged between the stationary fitting portion and the motor stator or the annular member.

18. The rotation support device for flying object according to claim 1, wherein
the rotating body has a rotating flange that protrudes toward an outside in a radial direction at a portion located further to a first side in an axial direction of the stationary body and to which the motor rotor and the propeller are able to be supported and fixed.

19. The rotation support device for flying object according to claim 1, wherein
the rotating body has a central hole that opens to an end surface on a first side in an axial direction and/or to an end surface a second side in the axial direction.
